(19) United States
(12) Patent Application Publication
(10) Pub. No.: US 2020/0157387 A1
(43) Pub. Date: May 21, 2020

(54) PRESSURE-SENSITIVE ADHESIVE LAYER, OPTICAL FILM PROVIDED WITH PRESSURE-SENSITIVE LAYER, OPTICAL LAMINATE, AND IMAGE DISPLAY DEVICE

(71) Applicant: NITTO DENKO CORPORATION, Ibaraki-shi, Osaka (JP)

(72) Inventors: Tomoyuki Kimura, Ibaraki-shi (JP); Hirotomo Ono, Ibaraki-shi (JP); Yusuke Toyama, Ibaraki-shi (JP)

(73) Assignee: NITTO DENKO CORPORATION, Ibaraki-shi, Osaka (JP)

(21) Appl. No.: 16/635,315

(22) PCT Filed: Aug. 7, 2018
(86) PCT No.: PCT/JP2018/029553

§ 371 Date: Jan. 30, 2020

(30) Foreign Application Priority Data
Aug. 7, 2017 (JP) 2017-152520

(51) Int. Cl. C09J 7/38; C09J 7/40; G02B 5/30; G09F 9/00

(52) U.S. Cl. CPC C09J 7/385; G09F 9/00; G02B 5/30; C09J 7/405

(57) ABSTRACT

A pressure-sensitive adhesive layer formed from a pressure-sensitive adhesive composition containing, as monomer units, at least a (meth)acrylic polymer (A) that contains an alkyl (meth)acrylate, and a silicon compound (B), wherein: the silicon compound (B) is an organopolysiloxane compound; and when a laminate, in which a pressure-sensitive adhesive layer of a polarizing film provided with a pressure-sensitive adhesive layer having the pressure-sensitive adhesive layer and a polarizing film is laminated to an indium-tin composite oxide layer on a transparent conductive substrate having a transparent substrate and the indium-tin composite oxide layer, has been autoclaved for 15 minutes at 50° C. and 5 atm, and then the pressure-sensitive adhesive layer has been peeled away, the ratio of elemental silicon relative to the total of elemental carbon, nitrogen, oxygen, silicon, indium, and tin detected by X-ray photoelectron spectroscopy is 0.5-5 atomic % in the surface of the indium-tin composite oxide layer.

### TECHNICAL FIELD

The present invention relates to a pressure-sensitive adhesive layer, an optical film having a pressure-sensitive adhesive layer, and an optical laminate. More specifically, the present invention relates to an image display device, such as a liquid crystal display, an organic EL display, or PDP, using the optical film having a pressure-sensitive adhesive layer or the optical laminate. As the optical film, a polarizing film, a retardation film, a compensation film, a brightness enhancement film, or a film obtained by laminating them can be used.

### BACKGROUND ART

A liquid crystal display or the like absolutely needs to have polarizing elements provided on both sides of its liquid crystal cell because of its image-forming method, and polarizing films are generally attached. Further, in addition to polarizing films, various optical elements have come to be used for a liquid crystal panel to improve the display quality of a display. Examples of such optical elements include a retardation film for preventing coloration, a viewing angle increasing film for improving the viewing angle of a liquid crystal display, and a brightness enhancement film for enhancing the contrast of a display. These films are collectively called optical films.

A pressure-sensitive adhesive is usually used when an optical member such as the above-described optical film is attached to a liquid crystal cell. An optical film and a liquid crystal cell or optical films are usually closely adhered to each other with a pressure-sensitive adhesive to reduce a loss of light. In such a case, an optical film having a pressure-sensitive adhesive layer, in which a pressure-sensitive adhesive is previously provided on one surface of an optical film as a pressure-sensitive adhesive layer, is generally used because there is an advantage that the optical film can be fixed without a drying process. A release film is usually attached to the pressure-sensitive adhesive layer of the optical film having a pressure-sensitive adhesive layer.

The pressure-sensitive adhesive layer is required to have durability when the optical film having a pressure-sensitive adhesive layer is adhered to the glass substrate of a liquid crystal panel. For example, in an endurance test, such as a heating and humidification test, usually performed as an environmental acceleration test, the optical film having a pressure-sensitive adhesive layer is require to cause no defect resulting from the pressure-sensitive adhesive layer, such as peeling or lifting.

For example, Patent Document 1 discloses, as a pressure-sensitive adhesive layer having such durability as described above, a pressure-sensitive adhesive layer formed of a pressure-sensitive adhesive composition containing an acrylic copolymer of a (meth)acrylic alkyl ester whose alkyl group has 1 to 18 carbon atoms and a functional group-containing monomer, a crosslinking agent, and a silane coupling agent having an acid anhydride group.

Further, from the viewpoint of enhancing the productivity of an image display device such as a liquid crystal display, the pressure-sensitive adhesive layer is required to have a property (reworkability) such that when adhered to the glass substrate of a liquid crystal panel, the optical film having a pressure-sensitive adhesive layer can easily be detached and the pressure-sensitive adhesive does not remain on the glass substrate after detachment.

On the other hand, there is a case where a transparent conductive layer (e.g., an indium-tin composite oxide layer (ITO layer)) is formed on the glass substrate of a liquid crystal panel. The transparent conductive layer functions as an antistatic layer for preventing display unevenness caused by static electricity, or functions as a shield electrode that separates a driving electric field in a liquid crystal cell and a touch panel from each other when a liquid crystal display is used as a touch panel. Further, in the case of a so-called on-cell touch panel-type liquid crystal panel, a patterned transparent conductive layer is directly formed on the glass substrate of an image display panel so as to function as a sensor electrode of the touch panel. In a liquid crystal display having such a structure, the pressure-sensitive adhesive layer of the optical film having a pressure-sensitive adhesive layer is directly adhered to a transparent conductive layer such as the above-described ITO layer. Therefore, the pressure-sensitive adhesive layer is required to have durability and reworkability not only against glass substrates but also against transparent conductive layers such as ITO layers. In general, adhesion of the pressure-sensitive adhesive layer to a transparent conductive layer such as an ITO layer is inferior to that to a glass substrate, which often causes a problem of durability.

### PRIOR ART DOCUMENTS

### Patent Documents

Patent Document 1: JP-A-2006-265349

### SUMMARY OF THE INVENTION

### Problems to be Solved by the Invention

Further, image display devices such as liquid crystal displays have recently been used as in-car devices. In-car image display devices are used in a higher temperature range than image display devices for home electrical appliances. Therefore, the pressure-sensitive adhesive layer is required to have durability (high durability) in a high temperature range and a high temperature and humidity range to prevent foaming or peeling.

However, the pressure-sensitive adhesive layer disclosed in the above-described Patent Document 1 is poor in such reworkability and high durability against a transparent conductive layer as described above.

In light of the above circumstances, it is an object of the present invention to provide a pressure-sensitive adhesive layer having reworkability and high durability against a transparent conductive layer.

Further, it is also an object of the present invention to provide an optical film having a pressure-sensitive adhesive layer which has the above-described pressure-adhesive layer, an optical laminate having the above-described optical film having a pressure-sensitive adhesive layer adhered thereto, and an image display device using the optical film having a pressure-sensitive adhesive layer or the optical laminate.

### Means for Solving the Problems

More specifically, the present invention relates to a pressure-sensitive adhesive layer including a pressure-sensitive adhesive composition containing a (meth)acrylic polymer (A) containing at least an alkyl (meth)acrylate as a monomer unit and a silicon compound (B), wherein the silicon compound (B) is an organopolysiloxane compound, and when a laminate, which is obtained by adhering the pressure-sensitive adhesive layer of a polarizing film having a pressure-sensitive adhesive layer which has a polarizing film and the pressure-sensitive adhesive layer to an indium-tin composite oxide layer of a transparent conductive substrate having a transparent substrate and an indium-tin composite oxide layer, is subjected to autoclave treatment under conditions of 50° C. and 5 atmospheres for 15 minutes, and then the pressure-sensitive adhesive layer is peeled off, a ratio of elemental silicon to a total amount of elemental carbon, nitrogen, oxygen, silicon, indium, and tin detected in a surface of the indium-tin composite oxide layer by X-ray photoelectron spectroscopy is 0.5 atomic % or more but 5 atomic % or less.

In the pressure-sensitive adhesive layer according to the present invention, an amount of the silicon compound (B) is preferably 0.05 to 10 parts by weight per 100 parts by weight of the (meth)acrylic polymer (A).

In the pressure-sensitive adhesive layer according to the present invention, it is preferred that the pressure-sensitive adhesive composition contains a reactive functional group-containing silane coupling agent, and the reactive functional group is at least one of an epoxy group, a mercapto group, an amino group, an isocyanate group, an isocyanurate group, a vinyl group, a styryl group, an acetoacetyl group, a ureido group, a thiourea group, a (meth)acrylic group, and a heterocyclic group.

In the pressure-sensitive adhesive layer according to the present invention, an amount of the reactive functional group-containing silane coupling agent is preferably 0.01 to 10 parts by weight per 100 parts by weight of the (meth)acrylic polymer (A). In the pressure-sensitive adhesive layer according to the present invention, an amount of the reactive functional group-containing silane coupling agent is preferably 0.01 to 10 parts by weight per 100 parts by weight of the (meth)acrylic polymer (A).

In the pressure-sensitive adhesive layer according to the present invention, it is preferred that the pressure-sensitive adhesive composition further contains, as a monomer unit, at least one copolymerizable monomer selected from the group consisting of

an aromatic-containing (meth)acrylate, an amide group-containing monomer, a carboxyl group-containing monomer, and a hydroxyl group-containing monomer.

In the pressure-sensitive adhesive layer according to the present invention, the amount of the carboxyl group-containing monomer is preferably 0.1 to 15% by weight with respect to a total amount of monomer components forming the (meth)acrylic polymer (A).

In the pressure-sensitive adhesive layer according to the present invention, the pressure-sensitive adhesive composition preferably contains a crosslinking agent.

The pressure-sensitive adhesive layer according to the present invention preferably has an adhesive force to an indium-tin composite oxide layer of 15 N/25 mm or less under conditions of a peel angle of 900 and a peel rate of 300 mm/min.

The present invention also relates to an optical film having a pressure-sensitive adhesive layer which includes an optical film and the above-described pressure-sensitive adhesive layer.

The present invention also relates to an optical laminate comprising a transparent conductive substrate having a transparent substrate and a transparent conductive layer and the above-described optical film having a pressure-sensitive adhesive layer, wherein the pressure-sensitive adhesive layer of the optical film having a pressure-sensitive adhesive layer is adhered to the transparent conductive layer of transparent conductive substrate.

The present invention also relates to an image display device using the above-described optical film having a pressure-sensitive adhesive layer or the above-described optical laminate.

### Effect of the Invention

The pressure-sensitive adhesive layer according to the present invention includes a pressure-sensitive adhesive composition containing a (meth)acrylic polymer (A) containing at least an alkyl (meth)acrylate as a monomer unit and a silicon compound (B), wherein the silicon compound (B) is an organopolysiloxane compound, and when a laminate, which is obtained by adhering the pressure-sensitive adhesive layer of a polarizing film having a pressure-sensitive adhesive layer which has a polarizing film and the pressure-sensitive adhesive layer to an indium-tin composite oxide layer of a transparent conductive substrate having a transparent substrate and an indium-tin composite oxide layer, is subjected to autoclave treatment under conditions of 50° C. and 5 atmospheres for 15 minutes, and then the pressure-sensitive adhesive layer is peeled off, a ratio of elemental silicon to a total amount of elemental carbon, nitrogen, oxygen, silicon, indium, and tin detected in a surface of the indium-tin composite oxide layer by X-ray photoelectron spectroscopy is 0.5 atomic % or more but 5 atomic % or less. Therefore, the pressure-sensitive adhesive layer according to the present invention has high durability against a transparent conductive layer even in an endurance test performed under severe high temperature or high temperature and humidity conditions that the pressure-sensitive adhesive layer is required to withstand when used in cars, and has excellent reworkability and therefore can easily be peeled off.

In the pressure-sensitive adhesive layer according to the present invention, it is preferred that the silicon compound (B) is an organopolysiloxane compound having an acidic group or an acid anhydride group derived from an acidic group in a molecule, and is contained in an amount of 0.05 to 10 parts by weight per 100 parts by weight of the (meth)acrylic polymer (A). When the silicon compound (B) has an acidic group or an acid anhydride group derived from an acidic group in a molecule, it is estimated that the acidic group or an acidic group generated by the hydrolysis of the acid anhydride group with time reacts with a transparent conductive layer such as an ITO layer in an acid-base reaction so that the silicon compound (B) is trapped at the interface between the transparent conductive layer and the pressure-sensitive adhesive layer. As a result, formation of a coating film by the silicon compound (B) is promoted, and therefore the ratio of elemental Si in the surface of the indium-tin composite oxide layer can easily be adjusted to be within an appropriate range. In addition, the ratio of elemental Si in the surface of the indium-tin composite oxide layer can be adjusted to be within an appropriate range by adjusting the silicon compound (B) content.

In the pressure-sensitive adhesive layer according to the present invention, it is preferred that the (meth)acrylic polymer (A) contains a carboxyl group-containing monomer as a monomer unit as long as the ratio of elemental Si in the surface of the indium-tin composite oxide layer is 0.5 atomic % or more but 5 atomic % or less. The carboxyl group-containing monomer is effective at improving durability against a transparent conductive layer, but there is a problem that the carboxyl group-containing monomer excessively increases adhesive force to a transparent conductive layer and deteriorates reworkability. However, by appropriately adjusting the copolymerization ratio of the carboxyl group-containing monomer in the pressure-sensitive adhesive layer of the present invention, it is possible to prevent an increase in adhesive force to a transparent conductive layer, thereby providing a pressure-sensitive adhesive layer that can achieve both high durability such that foaming and peeling do not occur even under severe endurance test conditions that in-car displays are required to withstand and excellent reworkability against a transparent conductive layer.

In the surface of a transparent conductive layer such as ITO, some of hydroxyl groups present in the surface of the transparent conductive layer are desorbed as hydroxide ions so that metallic cations (in the case of ITO, for example, indium cations) are generated in the surface of the transparent conductive layer. It is estimated that the carboxyl group of the (meth)acrylic polymer (A) causes a neutralization reaction with the hydroxide ion near the surface of the transparent conductive layer so that a carboxylate anion generated by deprotonation of the carboxyl group and the metallic cation in the surface of the transparent conductive layer form an ionic bond (that is, the carboxyl group of the (meth)acrylic polymer (A) and the transparent conductive layer react in an acid-base reaction), and therefore the carboxyl group of the (meth)acrylic polymer (A) and the transparent conductive layer are strongly bonded. If the amount of the carboxyl group-containing monomer is too large, segregation of the silicon compound (B) is likely to be inhibited by the formation of a bond with the transparent conductive layer. Therefore, in order to adjust the ratio of elemental Si in the surface of the indium-tin composite oxide layer to 0.5 atomic % or more but 5 atomic % or less, it is important to appropriately adjust the copolymerization ratio of the carboxyl group-containing monomer.

It is preferred that the pressure-sensitive adhesive layer according to the present invention has a moisture content of 0.1 wt % to 2.0 wt % under conditions of 23° C. and 55% RH. When the pressure-sensitive adhesive layer has a high moisture content, the ratio of elemental Si in the surface of the indium-tin composite oxide layer tends to become high. It is estimated that this results from the fact that when the pressure-sensitive adhesive layer has a high moisture content and is adhered to a transparent conductive layer, a larger amount of moisture is present at the interface between the transparent conductive layer and the pressure-sensitive adhesive layer, and therefore segregation of the silicon compound (B), which is a polysiloxane having higher hydrophilicity than the (meth)acrylic polymer (A), is promoted by the moisture. By appropriately adjusting the moisture content of the pressure-sensitive adhesive layer, the ratio of elemental Si in the surface of the indium-tin composite oxide layer can be adjusted to be within an appropriate range.

When the pressure-sensitive adhesive layer according to the present invention is adhered to a transparent conductive layer, it takes a certain period of time before the silicon compound (B) segregates at the interface between the transparent conductive layer and the pressure-sensitive adhesive layer. Therefore, aging treatment is preferably performed after adhesion to an adherend such as a transparent conductive layer. The time required for segregation of the silicon compound (B) tends to reduce as the temperature of the aging treatment increases. Therefore, it is preferred that the temperature and time of the aging treatment are appropriately set as long as the performance of the pressure-sensitive adhesive layer, an optical film, an image display panel, or an image display device is not impaired.

When the pressure-sensitive adhesive layer according to the present invention is adhered to a transparent conductive layer, a coating layer derived from the silicon compound (B) is formed at the interface between the transparent conductive layer and the pressure-sensitive adhesive layer. When the pressure-sensitive adhesive layer according to the present invention is peeled off from an adherend such as an image display panel, breakage of the coating layer promotes the peeling-off of the pressure-sensitive adhesive layer so that adhesive force can appropriately be reduced. Therefore, the pressure-sensitive adhesive layer according to the present invention has excellent reworkability.

A transparent conductive layer is generally less likely to adhere to the pressure-sensitive adhesive layer than glass, and therefore foaming or peeling of the pressure-sensitive adhesive layer is likely to occur. In the case of the pressure-sensitive adhesive layer according to the present invention, the silicon compound (B) segregates to a transparent conductive layer, and therefore organic functional groups are introduced into the interface between the transparent conductive layer and the pressure-sensitive adhesive layer. It is estimated that such organic functional groups derived from the silicon compound (B) function to improve adhesion to the pressure-sensitive adhesive layer in an endurance test performed under a high temperature condition or a high temperature and humidity condition by forming a bond with a polar group contained in the (meth)acrylic polymer (A) or forming a bond between molecules of the silicon compound (B). Therefore, the pressure-sensitive adhesive layer according to the present invention also has durability against a transparent conductive layer such that foaming or peeling can be prevented in an endurance test.

Particularly preferred examples of the polar group contained in the (meth)acrylic polymer (A) include a hydroxyl group, a carboxyl group, an amide group, an amino group, an alkoxysilyl group, and a silanol group.

When the pressure-sensitive adhesive composition forming the pressure-sensitive adhesive layer according to the present invention contains a silane coupling agent having at least one reactive functional group selected from an epoxy group, a mercapto group, an amino group, an isocyanate group, an isocyanurate group, a vinyl group, a styryl group, an acetoacetyl group, a ureido group, a thiourea group, a (meth)acrylic group, and a heterocyclic group, a combined action with the silicon compound (B) is estimated to be developed, and therefore a pressure-sensitive adhesive layer having more excellent high durability can be obtained.

### BRIEF DESCRIPTION OF THE DRAWING

FIG. 1 is a cross-sectional view schematically showing an embodiment of a liquid crystal panel that can be used in the present invention.

### MODE FOR CARRYING OUT THE INVENTION

Hereinbelow, embodiments of the present invention will be described in detail.

The present invention relates to a pressure-sensitive adhesive layer including a pressure-sensitive adhesive composition containing a (meth)acrylic polymer (A) containing at least an alkyl (meth)acrylate as a monomer unit and a silicon compound (B), wherein the silicon compound (B) is an organopolysiloxane compound, and when a laminate, which is obtained by adhering the pressure-sensitive adhesive layer of a polarizing film having a pressure-sensitive adhesive layer which has a polarizing film and the pressure-sensitive adhesive layer to an indium-tin composite oxide layer of a transparent conductive substrate having a transparent substrate and an indium-tin composite oxide layer, is subjected to autoclave treatment under conditions of 50° C. and 5 atmospheres for 15 minutes, and then the pressure-sensitive adhesive layer is peeled off, a ratio of elemental silicon to a total amount of elemental carbon, nitrogen, oxygen, silicon, indium, and tin detected in a surface of the indium-tin composite oxide layer by X-ray photoelectron spectroscopy is 0.5 atomic % or more but 5 atomic % or less.

In the pressure-sensitive adhesive layer according to the present invention, the upper limit of the ratio of elemental Si in the surface of the indium-tin composite oxide layer is preferably 4.0 atomic % or less, more preferably 3.0 atomic % or less, even more preferably 2,6 atomic % or less, particularly preferably 2.2 atomic % or less. The lower limit of the ratio of elemental Si in the surface of the indium-tin composite oxide layer is preferably 1.0 atomic % or more, more preferably 1.2 atomic % or more, even more preferably 1.4 atomic % or more, particularly preferably 1.6 atomic % or less.

The pressure-sensitive adhesive layer according to the present invention includes a pressure-sensitive adhesive composition containing a (meth)acrylic polymer (A) containing at least an alkyl (meth)acrylate as a monomer unit and a silicon compound (B). By combining the pressure-sensitive adhesive composition containing a (meth)acrylic polymer (A) containing an alkyl (meth)acrylate and a silicon compound (B) with the following formulations (a) to (d), the ratio of elemental Si in the surface of the indium-tin composite oxide layer can be adjusted to 0.5 atomic % or more but 5 atomic % or less. However, the combination of these formulations is merely illustrative, and formulations to be combined are not limited thereto.

(a) As the silicon compound (B), an organopolysiloxane having an acidic group or an acid anhydride group derived from an acidic group in a molecule is used and added in an amount of 0.05 to 10 parts by weight per 100 parts by weight of the (meth)acrylic polymer (A). This makes it possible to adjust the ratio of elemental Si in the surface of the indium-tin composite oxide layer, thereby further improving high durability and reworkability of the pressure-sensitive adhesive layer. The upper limit of the amount of the silicon compound (B) to be added is more preferably 3 parts by weight or less, even more preferably 2 parts by weight or less, particularly preferably 1 part by weight or less, most preferably 0.6 parts by weight or less. The lower limit of the amount of the silicon compound (B) to be added is more preferably 0.1 parts by weight or more, even more preferably 0.2 parts by weight or more, particularly preferably 0.4 parts by weight or more. If the amount of the silicon compound (B) to be added is too large, the ratio of elemental Si in the surface of the indium-tin composite oxide layer becomes too high so that durability tends to reduce, and if the amount of the silicon compound (B) to be added is too small, the ratio of elemental Si in the surface of the indium-tin composite oxide layer reduces so that durability and reworkability against a transparent conductive layer tend to reduce.

(b) When the carboxyl group-containing monomer is used as the monomer component, the carboxyl group-containing monomer is added in an amount of 0.1 to 15 wt % with respect to the total amount of the monomer components forming the (meth)acrylic polymer (A). This makes it possible to adjust the ratio of elemental Si in the surface of the indium-tin composite oxide layer, thereby further improving the durability of the pressure-sensitive adhesive layer. The upper limit of the amount of the carboxyl group-containing monomer to be copolymerized is more preferably 8 wt % or less, even more preferably 6 wt % or less. The lower limit of the amount of the carboxyl group-containing monomer to be copolymerized is more preferably 0.3 wt % or more, even more preferably 1 wt % or more, particularly preferably 4.5 wt % or more. If the amount of the carboxyl group-containing monomer to be copolymerized is too large, the ratio of elemental Si in the surface of the indium-tin composite oxide layer reduces so that durability and reworkability against a transparent conductive layer tend to deteriorate, and if the amount of the carboxyl group-containing monomer to be copolymerized is too small, durability tends to reduce.

(c) The moisture content of the pressure-sensitive adhesive layer under the conditions of 23° C. and 55% RH is set to 0.1 wt % to 2.0 wt %. The upper limit of the moisture content is more preferably 1.5 wt % or less, even more preferably 1.0 wt % or less, particularly preferably 0.8 wt % or less. The lower limit of the moisture content is more preferably 0.2 wt % or more, even more preferably 0.3 wt % or more, particularly preferably 0.4 wt % or more. If the moisture content is too high, foaming of the pressure-sensitive adhesive layer is likely to occur in an endurance test by heating or peeling-off of the pressure-sensitive adhesive layer is likely to occur in an endurance test by humidification, and if the moisture content is too low, the ratio of elemental Si in the surface of the indium-tin composite oxide layer reduces so that durability and reworkability against a transparent conductive layer tend to reduce.

(d) After the pressure-sensitive adhesive layer is adhered to a transparent conductive layer, aging treatment is performed under conditions of a treatment temperature of 5° C. to 90° C. and a treatment time of 1 minute to 24 hours. The treatment temperature is more preferably 15° C. to 80° C., particularly preferably 25° C. to 70° C. As for specific conditions for the aging treatment, when the treatment temperature is 50° C., the treatment time is 15 minutes, and when the treatment temperature is 25° C., the treatment time is 3 hours. When the aging temperature is too low, there is a problem that it takes a long time before the ratio of elemental Si in the surface of the indium-tin composite oxide layer falls within an appropriate range after the pressure-sensitive adhesive layer is adhered, and if the aging temperature is too high, there is a fear that the performance of the pressure-sensitive adhesive layer, an optical film, an image display panel, or an image display device is impaired.

### <(Meth)Acrylic Polymer (A)>

The (meth)acrylic polymer (A) used in the present invention contains the above-described alkyl (meth)acrylate as a main component. It is to be noted that “(meth)acrylate” refers to acrylate and/or methacrylate, and “(meth)” is used in the same sense in the present invention.

Examples of the alkyl (meth)acrylate constituting the main skeleton of the (meth)acrylic polymer (A) include those whose linear of branched alkyl group has 1 to 18 carbon atoms. Examples of the alkyl group include a methyl group, an ethyl group, a propyl group, an isopropyl group, a butyl group, an isobutyl group, an amyl group, a hexyl group, a cyclohexyl group, a heptyl group, a 2-ethylhexyl group, an isooctyl group, a nonyl group, a decyl group, an isodecyl group, a dodecyl group, an isomyristyl group, a lauryl group, a tridecyl group, a pentadecyl group, a hexadecyl group, a heptadecyl group, and an octadecyl group. The above-mentioned alkyl (meth)acrylates may be used singly or in combination of two or more of them. The average number of carbon atoms in the alkyl group is preferably 3 to 9.

As a monomer constituting the (meth)acrylic polymer (A) other than the alkyl (meth)acrylate, at least one copolymerizable monomer selected from the group consisting of an aromatic ring-containing (meth)acrylate, an amide group-containing monomer, a carboxyl group-containing monomer, and a hydroxyl group-containing monomer can be mentioned. These copolymerizable monomers may be used singly or in combination of two or more of them.

The aromatic ring-containing (meth)acrylate is a compound containing an aromatic ring structure in its structure and having a (meth)acryloyl group. Examples of the aromatic ring include a benzene ring, a naphthalene ring, a biphenyl ring. The aromatic ring-containing (meth)acrylate is effective at adjusting a phase difference caused by the application of stress to the pressure-sensitive adhesive layer due to the shrinkage of an optical film, and therefore the occurrence of light leakage caused by shrinkage of the optical film can be prevented.

Examples of the aromatic ring-containing (meth)acrylate include: benzene ring-containing (meth)acrylates such as benzyl (meth)acrylate, phenyl (meth)acrylate, o-phenylphenol (meth)acrylate, phenoxy (meth)acrylate, phenoxyethyl (meth)acrylate, phenoxypropyl (meth)acrylate, phenoxydiethyleneglycol (meth)acrylate, ethylene oxide-modified nonyl phenol (meth)acrylate, ethyleneoxide-modified cresol (meth)acrylate, phenolethylene oxide-modified (meth)acrylate, 2-hydroxy-3-phenoxypropyl (meth)acrylate, methoxybenzyl (meth)acrylate, chlorobenzyl (meth)acrylate, cresyl (meth)acrylate, and polystyryl (meth)acrylate; naphthalene ring-containing (meth)acrylates such as hydroxyethylated β-naphthol acrylate, 2-naphthoethyl (meth)acrylate, 2-naphthoxyethyl acrylate, and 2-(4-methoxy-1-naphthoxy)ethyl (meth)acrylate; and biphenyl ring-containing (meth)acrylates such as biphenyl (meth)acrylate. Among them, benzyl (meth)acrylate and phenoxyethyl (meth)acrylate are preferred from the viewpoint of improving the pressure-sensitive adhesive property and durability of the pressure-sensitive adhesive layer.

The amide group-containing monomer is a compound containing an amide group in its structure and having a polymerizable unsaturated double bond such as a (meth)acryloyl group or a vinyl group. Examples of the amide group-containing monomer include: acrylamide-based monomers such as (meth)acrylamide, N,N-dimethyl(meth)acrylamide, N,N-diethyl(meth)acrylamide, N-isopropylacrylamide, N-methyl(meth)acrylamide, N-butyl(meth)acrylamide, N-hexyl(meth)acrylamide, N-methylol (meth)acrylamide, N-methylol-N-propane(meth)acrylamide, aminomethyl (meth)acrylamide, aminoethyl (meth)acrylamide, mercaptomethyl (meth)acrylamide, and mercaptoethyl (meth)acrylamide; N-acryloyl heterocyclic monomers such as N-(meth)acryloylmorpholine, N-(meth)acryloyl piperidine, and N-(meth)acryloyl pyrrolidine; and N-vinyl group-containing lactam-based monomers such as N-vinyl pyrrolidone and N-vinyl-ε-caprolactam. Among them, an N-vinyl group-containing lactam-based monomer is preferred from the viewpoint of improving the durability of the pressure-sensitive adhesive layer against a transparent conductive layer.

The carboxyl group-containing monomer is a compound containing a carboxyl group in its structure and having a polymerizable unsaturated double bond such as a (meth)acryloyl group or a vinyl group. Examples of the carboxyl group-containing monomer include (meth)acrylic acid, carboxyethyl (meth)acrylate, carboxypentyl (meth)acrylate, itaconic acid, maleic acid, fumaric acid, and crotonic acid. Among them, acrylic acid is preferred from the viewpoint of copolymerizability, price, and improving the pressure-sensitive adhesive property of the pressure-sensitive adhesive layer.

The hydroxyl group-containing monomer is a compound containing a hydroxyl group in its structure and having a polymerizable unsaturated double bond such as a (meth)acryloyl group or a vinyl group. Examples of the hydroxyl group-containing monomer include: hydroxyalkyl (meth)acrylates such as 2-hydroxyethyl (meth)acrylate, 3-hydroxypropyl (meth)acrylate, 4-hydroxybutyl (meth)acrylate, 6-hydroxyhexyl (meth)acrylate, 8-hydoxyoctyl (meth)acrylate, 10-hydroxydecyl (meth)acrylate, and 12-hydroxylauryl (meth)acrylate; and (4-hydroxymethylcyclohexyl)-methylacrylate. Among them, 2-hydroxyethyl (meth)acrylate and 4-hydroxybutyl (meth)acrylate are preferred, and 4-hydroxybutyl (meth)acrylate is more preferred from the viewpoint of improving the durability of the pressure-sensitive adhesive layer.

When the pressure-sensitive adhesive composition contains a crosslinking agent that will be described later, the above-described copolymerizable monomer functions as a site of reaction with the crosslinking agent. The carboxyl group-containing monomer and the hydroxyl group-containing monomer are highly reactive with an intermolecular crosslinking agent, and are therefore preferably used to improve the cohesiveness and heat resistance of a resulting pressure-sensitive adhesive layer. Further, the carboxyl group-containing monomer is preferred from the viewpoint of achieving both durability and reworkability, and the hydroxyl group-containing monomer is preferred from the viewpoint of improving reworkability.

In the present invention, the amount of the alkyl (meth)acrylate is preferably 50 wt % or more with respect to the total amount of monomer components forming the (meth)acrylic polymer (A) from the viewpoint of improving the adhesiveness of the pressure-sensitive adhesive layer. The amount of the alkyl (meth)acrylate can freely be set as the balance of monomers other than the alkyl (meth)acrylate.

When the aromatic ring-containing (meth)acrylate is used as the monomer component, the amount of the aromatic ring-containing (meth)acrylate is preferably 3 to 25 wt % with respect to the total amount of the monomer components forming the (meth)acrylic polymer (A) from the viewpoint of improving the durability of the pressure-sensitive adhesive layer. The upper limit of the amount of the aromatic ring-containing (meth)acrylate to be copolymerized is more preferably 22 wt % or less, even more preferably 20 wt % or less. The lower limit of the amount of the aromatic ring-containing (meth)acrylate to be copolymerized is more preferably 8 wt % or more, even more preferably 12 wt % or more. If the amount of the aromatic ring-containing (meth)acrylate to be copolymerized is too large, light leakage tends to become worse due to the shrinkage of an optical film and reworkability tends to deteriorate. If the amount of the aromatic ring-containing (meth)acrylate to be copolymerized is too small, light leakage tends to become worse.

When the amide group-containing monomer is used as the monomer component, the amount of the amide group-containing monomer is preferably 0.1 to 20 wt % with respect to the total amount of the monomer components forming the (meth)acrylic polymer (A) from the viewpoint of improving the reworkability and durability of the pressure-sensitive adhesive layer. The upper limit of the amount of the amide group-containing monomer to be copolymerized is more preferably 10 wt % or less, even more preferably 4.5 wt % or less. The lower limit of the amount of the amide group-containing monomer to be copolymerized is more preferably 0.3 wt % or more, even more preferably 1 wt % or more. If the amount of the amide group-containing monomer to be copolymerized is too large, reworkability against glass particularly tends to deteriorate. If the amount of the amide group-containing monomer to be copolymerized is too small, durability tends to reduce.

When the hydroxyl group-containing monomer is used as the monomer component, the amount of the hydroxyl group-containing monomer is preferably 0.01 to 10 wt % with respect to the total amount of the monomer components forming the (meth)acrylic polymer (A) from the viewpoint of improving the pressure-sensitive adhesive property and durability of the pressure-sensitive adhesive layer. The upper limit of the amount of the hydroxyl group-containing monomer to be copolymerized is more preferably 5 wt % or less, even more preferably 2 wt % or less, particularly preferably 1 wt % or less. The lower limit of the amount of the hydroxyl group-containing monomer to be copolymerized is more preferably 0.03 wt % or more, even more preferably 0.05 wt % or more. If the amount of the hydroxyl group-containing monomer to be copolymerized is too large, durability tends to reduce due to the hardening of the pressure-sensitive adhesive. If the amount of the hydroxyl group-containing monomer to be copolymerized is too small, durability tends to reduce due to poor crosslinking of the pressure-sensitive adhesive.

In the present invention, as the monomer component, another copolymerizable monomer having a polymerizable functional group having an unsaturated double bond, such as a (meth)acryloyl group or a vinyl group, can be used in addition to the above-described alkyl (meth)acrylate and the above-described copolymerizable monomer for the purpose of improving the adhesiveness and heat resistance of the pressure-sensitive adhesive layer. The other copolymerizable monomers may be used singly or in combination of two or more of them.

Examples of the another copolymerizable monomer include: acid anhydride group-containing monomers such as maleic anhydride and itaconic anhydride; caprolactone adducts of acrylic acid; sulfonic acid group-containing monomers such as allylsulfonic acid, 2-(meth)acrylamido-2-methylpropanesulfonic acid, (meth)acrylamidopropanesulfonic acid, and sulfopropyl (meth)acrylate; phosphoric acid group-containing monomers such as 2-hydroxyethylacryloyl phosphate; alkylaminoalkyl (meth)acrylates such as aminoethyl (meth)acrylate, N,N-dimethylaminoethyl (meth)acrylate, and t-butylaminoethyl (meth)acrylate; alkoxyalkyl (meth)acrylates such as methoxyethyl (meth)acrylate and ethoxyethyl (meth)acrylate; succinimide-based monomers such as N-(meth)acryloyloxymethylenesuccinimide, N-(meth)acryloyl-6-oxyhexamethylenesuccinimide, and N-(meth)acryloyl-8-oxyoctamethylenesuccinimide; maleimide-based monomers such as N-cyclohexylmaleimide, N-isopropylmaleimide, N-laurylmaleimide, and N-phenylmaleimide; itaconimide-based monomers such as N-methylitaconimide, N-ethylitaconimide, N-butylitaconimide, N-octylitaconimide, N-2-ethylhexylitaconimide, N-cyclohexylitaconimide, and N-laurylitaconimide; vinyl-based monomers such as vinyl acetate and vinyl propionate; cyanoacrylate-based monomers such as acrylonitrile and methacrylonitrile; epoxy group-containing (meth)acrylates such as glycidyl (meth)acrylate; glycol-based (meth)acrylates such as polyethylene glycol (meth)acrylate, polypropylene glycol (meth)acrylate, methoxyethylene glycol (meth)acrylate, and methoxypolypropylene glycol (meth)acrylate; (meth)acrylate monomers such as tetrahydrofurfuryl (meth)acrylate, fluoro(meth)acrylate, silicone (meth)acrylate, and 2-methoxyethyl acrylate; and silicon atom-containing silane-based monomers such as 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltriethoxysilane, 10-methacryloyloxydecyltriethoxysilane, and 10-acryloyloxydecyltriethoxysilane.

Other examples of the another copolymerizable monomer include polyfunctional monomers having two or more unsaturated double bonds, such as tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate.

When the another copolymerizable monomer is used as the monomer component, the amount of the another copolymerizable monomer is preferably 10 wt % or less, more preferably 7 wt % or less, even more preferably 5 wt % or less with respect to the total amount of the monomer components forming the (meth)acrylic polymer (A).

### <Method for Producing (Meth)Acrylic Polymer (A)>

The (meth)acrylic polymer (A) can be produced by a known production method appropriately selected from various radical polymerization methods such as solution polymerization, radiation polymerization such as electron beam polymerization or UV polymerization, bulk polymerization, and emulsion polymerization. The resulting (meth)acrylic polymer (A) may be, for example, any one of a random copolymer, a block copolymer, and a graft copolymer.

It is to be noted that in the solution polymerization, for example, ethyl acetate or toluene is used as a polymerization solvent. In a specific example of the solution polymerization, the reaction is usually performed in a stream of an inert gas such as nitrogen at about 50 to 70° C. for about 5 to 30 hours in the presence of a polymerization initiator.

A polymerization initiator, a chain transfer agent, an emulsifier, and the like used in the radical polymerization are not particularly limited and can be appropriately selected. It is to be noted that the weight-average molecular weight of the (meth)acrylic polymer (A) can be controlled by the amount of the polymerization initiator or the chain transfer agent to be used or reaction conditions. The amount of the polymerization initiator or the chain transfer agent to be used is appropriately adjusted depending on the type thereof.

Examples of the polymerization initiator include, but are not limited to; azo-based initiators such as 2,2′-azobisisobutyronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (manufactured by Wako Pure Chemical Industries, Ltd., VA-057); persulfates such as potassium persulfate and ammonium persulfate; peroxide-based initiators such as di(2-ethylhexyl) peroxydicarbonate, di(4-t-butylcyclohexyl) peroxydicarbonate, di-sec-butyl peroxydicarbonate, t-butyl peroxyneodecanoate, t-hexyl peroxypivalate, t-butyl peroxypivalate, dilauroyl peroxide, di-n-octanoyl peroxide, 1,1,3,3-tetramethylbutyl peroxy-2-ethylhexanoate, di(4-methylbenzoyl) peroxide, dibenzoyl peroxide, t-butyl peroxyisobutyrate, 1,1-di(t-hexylperoxy)cyclohexane, t-butyl hydroperoxide, and hydrogen peroxide; and redox-based initiators using a peroxide and a reducing agent in combination, such as a combination of a persulfate and sodium hydrogen sulfite and a combination of a peroxide and sodium ascorbate.

These polymerization initiators may be used singly or in combination of two or more of them. However, the total amount of the polymerization initiators to be used is preferably about 0.005 to 1 part by weight, more preferably about 0.01 to 0.5 parts by weight per 100 parts by weight of the monomer component.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol. These chain transfer agents may be used singly or in combination of two or more of them. However, the total amount of the chain transfer agents to be used is about 0.1 parts by weight or less per 100 parts by weight of the monomer component.

Examples of the emulsifier used for emulsion polymerization include: anionic emulsifiers such as sodium lauryl sulfate, ammonium lauryl sulfate, sodium dodecylbenzene sulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymer. These emulsifiers may be used singly or in combination of two or more of them.

Specific examples of the emulsifier having a radical polymerizable functional group, such as a propenyl group or an allyl ether group, introduced thereinto, that is, a reactive emulsifier include Aqualon HS-10, HS-20, KH-10, BC-05, BC-10, and BC-20 (all manufactured by DKS Co., Ltd.) and ADEKA REASOAP SEION (manufactured by ADEKA Corporation). The reactive emulsifier is taken into a polymer chain after polymerization, and is therefore preferred from the viewpoint of improving water resistance. The amount of the emulsifier to be used is preferably 0.3 to 5 parts by weight per 100 parts by weight of the total amount of the monomer components. From the viewpoint of polymerization stability and mechanical stability, the amount of the emulsifier to be used is more preferably 0.5 to 1 part by weight per 100 parts by weight of the total amount of the monomer components.

When the (meth)acrylic polymer (A) is produced by radiation polymerization, the monomer component is polymerized by exposure to radiation such as electron beams or UV rays. When the radiation polymerization is performed using electron beams, it is not particularly necessary to add a photopolymerization initiator to the monomer component. However, when the radiation polymerization is performed by UV polymerization, a photopolymerization initiator may be added to the monomer component because there is an advantage that polymerization time can particularly be reduced. The photopolymerization initiators may be used singly or in combination of two or more of them.

The photopolymerization initiator is not particularly limited as long as photopolymerization can be initiated, and may be one usually used. Examples of such a photopolymerization initiator include benzoin ether-based, acetophenone-based, α-ketol-based, photoactive oxime-based, benzoin-based, benzyl-based, benzophenone-based, ketal-based, and thioxanthone-based photopolymerization initiators. The amount of the photopolymerization initiator to be used is 0.05 to 1.5 parts by weight, preferably 0.1 to 1 part by weight per 100 parts by weight of the monomer component. These photopolymerization initiators may be used singly or in combination of two or more of them.

The (meth)acrylic polymer (A) usually used has a weight-average molecular weight of 1,000,000 to 2,500,000. In consideration of durability, especially heat resistance, the weight-average molecular weight is preferably 1,200,000 to 2,000,000. A weight-average molecular weight of less than 1,000,000 is not preferred in terms of heat resistance. If the weight-average molecular weight exceeds 2,500,000, the pressure-sensitive adhesive tends to become hard so that peeling is likely to occur. The molecular weight distribution of the (meth)acrylic polymer (A) represented as weight-average molecular weight (Mw)/number-average molecular weight (Mn) is preferably 1.8 to 10, more preferably 1.8 to 7, even more preferably 1.8 to 5. A molecular weight distribution (Mw/Mn) of more than 10 is not preferred in terms of durability. It is to be noted that the weight-average molecular weight and the molecular weight distribution (Mw/Mn) are determined from values measured by gel permeation chromatography (GPC) and calculated against polystyrene standards.

### <Silicon Compound (B)>

The silicon compound (B) used in the present invention is an organopolysiloxane compound. The organopolysiloxane compound is also called a modified silicone oil, and is obtained by introducing an organic group into the side chain and/or terminal of silicone oil (dimethyl silicone oil). The organic group may be present at either both or one of terminals of a molecule. In the pressure-sensitive adhesive layer according to the present invention, the organic group is not particularly limited as long as the ratio of elemental Si in the surface of the indium-tin composite oxide layer is 0.5 atomic % or more but 5 atomic % or less, and examples of the organic group include: reactive organic groups such as a (meth)acryloyl group, an epoxy group, an amino group, a hydroxyl group, a carboxyl group, a carbinol group, a mercapto group, and an acid anhydride group; and nonreactive organic groups such as a polyether-modified (oxyalkylene chain-containing) organic group, an alkyl-modified organic group, an aralkyl-modified organic group, a higher fatty acid amide-modified organic group, a higher fatty acid ester-modified organic group, and a fluorine-modified organic group. The silicon compounds (B) may be used singly or in combination of two or more of them.

Examples of the polyether-modified (oxyalkylene chain-containing) organopolysiloxane compound include compounds having the following structures:

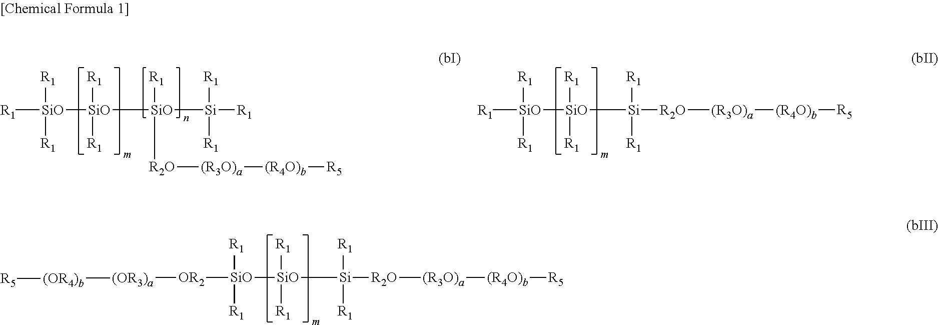

(in the formula (bI), R₁s are each a monovalent organic group, R₂, R₃, and R₄ are each an alkylene group, R₅ is a hydrogen atom or an organic group, m and n are integers of 0 to 1000 (m and n are not 0 at the same time), and a and b are integers of 0 to 1000 (a and b are not 0 at the same time)),

(in the formula (bII), R₁s are each a monovalent organic group, R₂, R₃, and R₄ are each an alkylene group, R₅ is a hydrogen atom or an organic group, m is an integer of 1 to 2000, and a and b are integers of 0 to 1000 (a and b are not 0 at the same time)),

(in the formula (bIII), R₁s are each a monovalent organic group, R₂s, R₃s, and R₄s are each an alkylene group, R₅s are each a hydrogen atom or an organic group, m is an integer of 1 to 2000, and a and b are integers of 0 to 1000 (a and b are not 0 at the same time)),

Examples of a commercially-available product of the polyether-modified (oxyalkylene chain-containing) organopolysiloxane compound include “KF-351A”, “KF-353”, “KF-945”, “KF-6011”, “KF-889”, and “KF-6004” (trade names) manufactured by Shin-Etsu Chemical Co., Ltd., “FZ-2122”, “FZ-2164”, “FZ-7001”, “SH8400”, “SH8700”, “SF8410”, and “SF8422” (trade names) manufactured by Dow Corning Toray Co., Ltd., “TSF-4440”, “TSF-4445”, “TSF-4452”, “and TSF-4460” (trade names) manufactured by Momentive Performance Materials Inc., and “BYK-333”, “BYK-377”, “BYK-UV3500”, and “BYK-UV3570” (trade names) manufactured by BYK Japan KK.

From the viewpoint of promoting segregation by an acid-base reaction with a transparent conductive layer such as an ITO layer, the organopolysiloxane compound preferably has an acidic group or an acid anhydride group derived from an acidic group in a molecule, more preferably has a carboxylic anhydride group such as a succinic anhydride group, a phthalic anhydride group, or a maleic anhydride group in a molecule, and even more preferably has, in a molecule, an acid anhydride group that is an organic group represented by the following general formula (1).

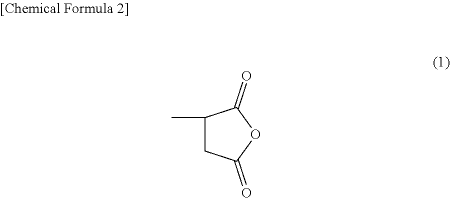

Examples of the organopolysiloxane compound include, but are not limited to, organopolysiloxane compounds (b1) which have an alkoxy group and an acid anhydride group in a molecule and in which at least one kind of siloxane unit is introduced by forming a siloxane bond between an O atom and an Si atom in at least one O—Si bond present in the molecule of an alkoxysilane represented by a general formula (2): R¹ₙSi(OR²)₄₋ₙ (wherein R¹ is independently a hydrogen atom or a C1 to C20 monovalent hydrocarbon group that may be substituted with a halogen atom, R²s are each independently an alkyl group having 1 to 10 carbon atoms, and n is an integer of 0 or 1) or a partial hydrolytic condensate thereof, wherein the siloxane unit to be introduced contains 1 to 100 siloxane units represented by a formula A of the following general formula (3) and 0 to 100 siloxane units represented by a formula B of the following general formula (3) and introduced if necessary:

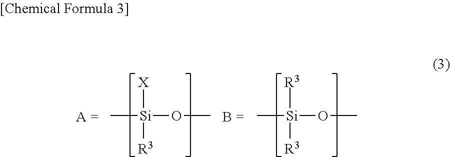

(wherein X is a monovalent hydrocarbon group having an acid anhydride group, preferably a monovalent hydrocarbon group containing an organic group represented by the following general formula (4), R³s are each independently a hydrogen atom or a C1 to C20 monovalent hydrocarbon group that may be substituted with a halogen atom).

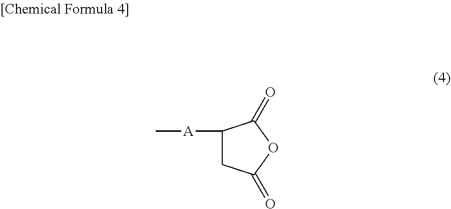

wherein A is a linear or branched alkylene or alkenylene group having 2 to 10 carbon atoms, preferably a linear or branched alkylene group having 2 to 6 carbon atoms).

Examples of the alkoxysilane represented by the above general formula (2) or the partial hydrolytic condensate thereof include tetramethoxysilane, methyltrimethoxysilane, tetraethoxysilane, methyltriethoxysilane, and partial hydrolytic condensate of each of these silanes or a combination of two or more of these silanes.

The number of the siloxane units represented by the formula A of the general formula (3) is preferably 1 to 100, more preferably 1 to 50, even more preferably 1 to 20. Further, the number of the siloxane units represented by the formula B of the general formula (3) and introduced if necessary is preferably 0 to 100, more preferably 0 to 50, even more preferably 0 to 20. When the siloxane unit represented by the formula B is contained, the number of the siloxane units represented by the formula B is preferably 1 or more. It is to be noted that the above different siloxane units may be introduced into the same O—Si bond or may separately be introduced into different O—Si bonds.

Other examples of the organopolysiloxane compound include organopolysiloxane compounds (b2) which have an alkoxy group, an acid anhydride group, and a polyether group in a molecule and in which at least two kinds of siloxane units are introduced by forming a siloxane bond between an O atom and an Si atom in at least one O—Si bond present in the molecule of an alkoxysilane represented by the above general formula (2) or a partial hydrolytic condensate thereof, wherein the siloxane unit to be introduced contains 1 to 100 siloxane units represented by a formula A of the following general formula (5), 1 to 100 siloxane units represented by a formula C of the following general formula (5), and 0 to 100 siloxane units represented by a formula B of the following general formula

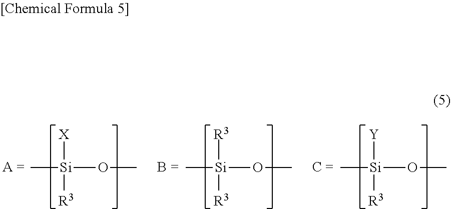

(wherein X is a monovalent hydrocarbon group having an acid anhydride group, preferably a monovalent hydrocarbon group containing an organic group represented by the above general formula (4), Y is a monovalent hydrocarbon group having a polyether group, and R³s are each independently a hydrogen atom or a C1 to C20 monovalent hydrocarbon group that may be substituted with a halogen atom).

A method for producing the organopolysiloxane compounds (b1) and (b2) is not particularly limited. For example, the organopolysiloxane compounds (b1) and (b2) can be obtained by a known production method disclosed in JP-A-2013-129809 or JP-A-2013-129691.

The silicon compound (B) is preferably the organopolysiloxane compound (b1) from the viewpoint of further improving high durability of the pressure-sensitive adhesive layer.

### <Reactive Functional Group-Containing Silane Coupling Agent>

The pressure-sensitive adhesive composition used in the present invention may contain a reactive functional group-containing silane coupling agent. The reactive functional group-containing silane coupling agent contains, as the reactive functional group, at least one of an epoxy group, a mercapto group, an amino group, an isocyanate group, an isocyanurate group, a vinyl group, a styryl group, an acetoacetyl group, a ureido group, a thiourea group, a (meth)acrylic group, and a heterocyclic group. The reactive functional group-containing silane coupling agents may be used singly or in combination of two or more of them.

Examples of the reactive functional group-containing silane coupling agent include: epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; mercapto group-containing silane coupling agents such as 3-mercaptopropylmethyldimethoxysilane and 3-mercaptopropyltrimethoxysilane; amino group-containing silane coupling agents such as 3-aminopropyltrimethoxysilane, N-2-(aminoethyl)-3-aminopropylmethyldimethoxysilane, 3-triethoxysilyl-N-(1,3-dimethylbutylidene)propylamine, and N-phenyl-γ-aminopropyltrimethoxysilane; isocyanate group-containing silane coupling agents such as 3-isocyanatopropyltriethoxysilane; vinyl group-containing silane coupling agents such as vinyltrimethoxysilane and vinyltriethoxysilane; styryl group-containing silane coupling agents such as p-styryltrimethoxysilane; and (meth)acrylic group-containing silane coupling agents such as 3-acryloxypropyltrimethoxysilane and 3-methacryloxypropyltriethoxysilane. Among them, epoxy group-containing silane coupling agents and mercapto group-containing silane coupling agents are preferred.

As the reactive functional group-containing silane coupling agent, one having two or more alkoxysilyl groups in its molecule (oligomer-type silane coupling agent) may also be used. Specific examples thereof include: epoxy group-containing oligomer-type silane coupling agents manufactured by Shin-Etsu Chemical Co., Ltd. under the trade names of “X-41-1053”, “X-41-1059A”, “X-41-1056”, and “X-40-2651”; and mercapto group-containing oligomer-type silane coupling agents manufactured by Shin-Etsu Chemical Co., Ltd. under the trade names of “X-41-1818”, “X-41-1810”, and “X-41-1805”. The oligomer-type silane coupling agent is preferred because it is less likely to evaporate, and has two or more alkoxysilyl groups and is therefore effective at improving durability.

When the reactive functional group-containing silane coupling agent is added to the pressure-sensitive adhesive composition, the amount of the reactive functional group-containing silane coupling agent is preferably 0.001 to 5 parts by weight per 100 parts by weight of the (meth)acrylic polymer (A). The upper limit of the amount of the reactive functional group-containing silane coupling agent to be added is more preferably 1 part by weight or less, even more preferably 0.6 parts by weight or less. The lower limit of the amount of the reactive functional group-containing silane coupling agent to be added is more preferably 0.01 parts by weight or more, even more preferably 0.05 parts by weight or more, particularly preferably 0.1 parts by weight or more. If the amount of the reactive functional group-containing silane coupling agent added is too large, durability tends to reduce, and if the amount of the reactive functional group-containing silane coupling agent to be added is too small, its effect on improving durability tends to be poor.

Further, when the reactive functional group-containing silane coupling agent is added to the pressure-sensitive adhesive composition, the weight ratio between the silicon compound (B) and the reactive functional group-containing silane coupling agent (silicon compound (B)/reactive functional group-containing silane agent) is preferably 0.1 or more, more preferably 0.5 or more, even more preferably 1 or more and is preferably 50 or less, more preferably 15 or less, even more preferably 5 or less from the viewpoint of improving the durability of the pressure-sensitive adhesive layer.

### <Crosslinking Agent>

The pressure-sensitive adhesive composition used in the present invention may contain a crosslinking agent. The crosslinking agent to be used may be an organic crosslinking agent, a polyfunctional metallic chelate, or the like. Examples of the organic crosslinking agent include an isocyanate-based crosslinking agent, a peroxide-based crosslinking agent, an epoxy-based cross-linking agent, and an imine-based crosslinking agent. The polyfunctional metallic chelate contains a polyvalent metal and an organic compound which are covalently or coordinately bonded to each other. Examples of the polyvalent metallic atom include Al, Cr, Zr, Co, Cu, Fe, Ni, V, Zn, In, Ca, Mg, Mn, Y, Ce, Sr, Ba, Mo, La, Sn, and Ti. The organic compound contains an oxygen atom or the like as an atom that forms a covalent or coordinate bond. Examples of the organic compound include alkyl esters, alcohol compounds, carboxylic compounds, ether compounds, and ketone compounds. The crosslinking agents may be used singly or in combination of two or more of them.

The crosslinking agent is preferably an isocyanate-based crosslinking agent and/or a peroxide-based crosslinking agent, more preferably a combination of an isocyanate-based crosslinking agent and a peroxide-based crosslinking agent.

The isocyanate-based crosslinking agent to be used may be a compound having at least two isocyanate groups (including functional groups obtained by temporarily protecting isocyanate groups with a blocking agent or by oligomerization so as to convertible to isocyanate groups). Examples of such a compound include known aliphatic polyisocyanate, alicyclic polyisocyanate, and aromatic polyisocyanate that are generally used for urethanization reaction.

Examples of the aliphatic polyisocyanate include trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, and 2,4,4-trimethylhexamethylene diisocyanate.

Examples of the alicyclic isocyanate include 1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, and hydrogenated tetramethylxylylene diisocyanate.

Examples of the aromatic diisocyanate include phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, and xylylene diisocyanate.

Other examples of the isocyanate-based crosslinking agent include multimers (e.g., dimers, trimers, pentamers), urethane-modified products obtained by reaction with a polyhydric alcohol such as trimethylolpropane, urea-modified products, biuret-modified products, allophanate-modified products, isocyanurate-modified products, and carbodiimide-modified products of the above-mentioned diisocyanates.

Examples of a commercially-available product of the isocyanate-based crosslinking agent include products manufactured by Nippon Polyurethane Industry Co., Ltd. under the trade names of “Millionate MT” “Millionate MTL”, “Millionate MR-200”, “Millionate MR-400”, “Coronate L”, “Coronate HL”, and “Coronate HX” and products manufactured by Mitsui Chemicals Inc. under the trade names of “TAKENATE D-110N”, “TAKENATE D-120N” “TAKENATE D-140N” “TAKENATE D-160N” “TAKENATE D-165N”, “TAKENATE D-170HN”, “TAKENATE D-178N”, “TAKENATE 500”, and “TAKENATE 600”.

The isocyanate-based crosslinking agent is preferably an aromatic polyisocyanate, an aromatic polyisocyanate-based compound that is a modified product of the aromatic polyisocyanate, an aliphatic polyisocyanate, or an aliphatic polyisocyanate-based compound that is a modified product of the aliphatic polyisocyanate. The aromatic polyisocyanate-based compound is suitably used for its excellent balance between crosslinking speed and pot life. Particularly preferred examples of the aromatic polyisocyanate-based compound include tolylenediisocyanate and modified products thereof.

The peroxide can appropriately be used as long as it generates a radical active species by heating or light irradiation to promote the crosslinking of the base polymer ((meth)acrylic polymer (A)) of the pressure-sensitive adhesive composition. In consideration of workability and stability, a peroxide whose one-minute half-life temperature is 80° C. to 160° C. is preferably used, and a peroxide whose one-minute half-life temperature is 90° C. to 140° C. is more preferably used.

Examples of the peroxide include di(2-ethylhexyl)peroxydicarbonate (one-minute half-life temperature: 90.6° C.), di(4-t-butylcyclohexyl)peroxydicarbonate (one-minute half-life temperature: 92.1° C.), di-sec-butylperoxydicarbonate (one-minute half-life temperature: 92.4° C.), t-butylperoxyneodecanoate (one-minute half-life temperature: 103.5° C.), t-hexylperoxypivalate (one-minute half-life temperature: 109.1° C.), t-butylperoxypivalate (one-minute half-life temperature: 110.3° C.), dilauroylperoxide (one-minute half-life temperature: 116.4° C.), di-n-octanoylperoxide (one-minute half-life temperature: 117.4° C.), 1,1,3,3-tetramethylbutylperoxy-2-ethylhexanoate (one-minute half-life temperature: 124.3° C.), di(4-methylbenzoyl)peroxide (one-minute half-life temperature: 128.2° C.), dibenzoylperoxide (one-minute half-life temperature: 130.0° C.), t-butylperoxyisobutyrate (one-minute half-life temperature: 136.1° C.), and 1,1-di(t-hexylperoxy)cyclohexane (one-minute half-life temperature: 149.2° C.). Among them, di(4-t-butylcyclohexyl)peroxydicarbonate (one-minute half-life temperature: 92.1° C.), dilauroyl peroxide (one-minute half-life temperature: 116.4° C.), and dibenzoylperoxide (one-minute half-life temperature: 130.0° C.) are particularly excellent in crosslinking reaction efficiency.

It is to be noted that the half-life of a peroxide is an indicator of the decomposition speed of the peroxide, and refers to the time it takes to reduce the amount of the peroxide to half its initial amount. The decomposition temperatures at which specific half-life times of peroxides are obtained and the half-life times of peroxides at specific temperatures are shown in manufacturer's catalogs such as “ORGANIC PEROXIDES 9th EDITION (May, 2003)” of NOF Corporation.

When the crosslinking agent is added to the pressure-sensitive adhesive composition, the amount of the crosslinking agent is preferably 0.01 to 3 parts by weight, more preferably 0.02 to 2 parts by weight, even more preferably 0.03 to 1 part by weight per 100 parts by weight of the (meth)acrylic polymer (A). It is to be noted that if the amount of the crosslinking agent is less than 0.01 parts by weight, there is a fear that the pressure-sensitive adhesive layer cannot have satisfactory durability and pressure-sensitive adhesive property due to poor crosslinking. On the other hand, if the amount of the crosslinking agent exceeds 3 parts by weight, the pressure-sensitive adhesive layer tends to be excessively hard and therefore have low durability.

When the isocyanate-based crosslinking agent is added to the pressure-sensitive adhesive composition, the amount of the isocyanate-base crosslinking agent is preferably 0.01 to 2 parts by weight, more preferably 0.02 to 2 parts by weight, even more preferably 0.05 to 1.5 parts by weight per 100 parts by weight of the (meth)acrylic polymer (A). From the viewpoint of cohesive force and preventing peeling in an endurance test, the amount of the isocyanate-based crosslinking agent is appropriately selected from the above range.

When the peroxide is added to the pressure-sensitive adhesive composition, the amount of the peroxide is preferably 0.01 to 2 parts by weight, more preferably 0.04 to 1.5 parts by weight, even more preferably 0.05 to 1 part by weight per 100 parts by weight of the (meth)acrylic polymer. In order to adjust processability and crosslinking stability, the amount of the peroxide is appropriately selected from the above range.

### <Other Components>

The pressure-sensitive adhesive composition used in the present invention may contain an ionic compound. The ionic compound is not particularly limited, and an ionic compound used in this field may suitably be used. Examples of such an ionic compound include those disclosed in JP 2015-4861 A. Among them, (perfluoroalkylsulfonyl)imide lithium salts are preferred, and lithium bis(trifluoromethanesulfonylimide) is more preferred. The ratio of the ionic compound is not particularly limited as long as the effects of the present invention are not impaired. For example, the ratio of the ionic compound is preferably 10 parts by weight or less, more preferably 5 parts by weight or less, even more preferably 3 parts by weight or less, particularly preferably 1 part by weight or less per 100 parts by weight of the (meth)acrylic polymer (A).

The pressure-sensitive adhesive composition used in the present invention may contain other known dopants. For example, the following dopants may appropriately be added depending on the intended use: polyether compounds of polyalkylene glycols such as polypropylene glycols, powders of colorants or pigments, dyes, surfactants, plasticizers, tackifiers, surface lubricants, leveling agents, softeners, antioxidants, anti-aging agents, light stabilizers, UV absorbers, polymerization inhibitors, inorganic or organic fillers, metallic powders, and granular or foil-shaped materials. A redox system may be used by adding a reducing agent within a controllable range. The amount of these dopants to be used is preferably 5 parts by weight or less, more preferably 3 parts by weight or less, even more preferably 1 part by weight or less per 100 parts by weight of the (meth)acrylic polymer (A).

### <Pressure-Sensitive Adhesive Layer>

The pressure-sensitive adhesive layer is formed using the pressure-sensitive adhesive composition. When the pressure-sensitive adhesive layer is formed, it is preferred that the total amount of the crosslinking agents to be added is adjusted and the effects of the temperature and time of crosslinking treatment are sufficiently taken into consideration.

The temperature and time of crosslinking treatment can be adjusted depending on the type of crosslinking agent used. The temperature of crosslinking treatment is preferably 170° C. or less. The crosslinking treatment may be performed at the same temperature as in the step of drying the pressure-sensitive adhesive layer, or may be performed in a crosslinking treatment step separately provided after the drying step. The time of crosslinking treatment can be set in consideration of productivity and workability, but is usually about 0.2 to 20 minutes, preferably about 0.5 to 10 minutes.

A method for forming the pressure-sensitive adhesive layer is not particularly limited, and may be a method in which the pressure-sensitive adhesive composition is applied onto any substrate, dried with a drier such as a heating oven to evaporate a solvent or the like, and if necessary, subjected to the above-described crosslinking treatment to form a pressure sensitive adhesive layer, and the pressure-sensitive adhesive layer is transferred onto an optical film or a transparent conductive substrate that will be described later. Alternatively, the pressure-sensitive adhesive layer may be formed by directly applying the pressure-sensitive adhesive composition onto the optical film or the transparent conductive substrate. In the present invention, a method is preferred in which an optical film having a pressure-sensitive adhesive layer is previously formed by forming a pressure-sensitive adhesive layer on an optical film, and then the optical film having a pressure-sensitive adhesive layer is attached to a liquid crystal cell.

The substrate is not particularly limited, and examples thereof include various substrates such as a release film, a transparent resin film substrate, and a polarizing film that will be described later.

Various methods may be used to apply the pressure-sensitive adhesive composition onto the substrate or the optical film. Specific examples thereof include methods such as fountain coater, roll coating, kiss-roll coating, gravure coating, reverse coating, roll brushing, spray coating, dip roll coating, bar coating, knife coating, air knife coating, curtain coating, lip coating, and extrusion coating suing a die coater.

Conditions (temperature, time) for the drying are not particularly limited, and may be appropriately set depending on, for example, the composition and concentration of the pressure-sensitive adhesive composition. The temperature is, for example, about 80 to 170° C., preferably 90 to 200° C., and the time is, for example, 1 to 60 minutes, preferably 2 to 30 minutes. If necessary, crosslinking treatment may be performed after drying, and conditions therefor are as described above.

The thickness of the pressure-sensitive adhesive layer (after drying) is, for example, preferably 5 to 100 μm, more preferably 7 to 70 μm, even more preferably 10 to 50 μm. If the thickness of the pressure-sensitive adhesive layer is less than 5 μm, the pressure-sensitive adhesive layer is poor in adhesiveness to an adherend, and therefore its durability tends to be poor under humidified conditions. On the other hand, if the thickness of the pressure-sensitive adhesive layer exceeds 100 μm, the pressure-sensitive adhesive composition is not sufficiently dried when applied and dried to form the pressure-sensitive adhesive layer so that foam remains and the pressure-sensitive adhesive layer has surface irregularities causing thickness variations, and therefore a problem in external appearance is likely to become apparent.

Examples of a material constituting the release film include appropriate thin sheet-shaped materials such as resin films such as polyethylene, polypropylene, polyethylene terephthalate, and polyester films, porous materials such as paper, fabric, and nonwoven fabric, nets, foamed sheets, metallic foils, and laminates of two or more of them. From the viewpoint of excellent surface smoothness, resin films are suitably used. Examples of the resin films include polyethylene films, polypropylene films, polybutene films, polybutadiene films, polymethylpentene films, polyvinyl chloride films, vinyl chloride copolymer films, polyethylene terephthalate film, polybutylene terephthalate films, polyurethane films, and ethylene-vinyl acetate copolymer films.

The thickness of the release film is usually about 5 to 200 μm, preferably about 5 to 100 μm. If necessary, the release film may be subjected to release and antifouling treatment using a silicone-, fluorine-, long chain alkyl- or fatty acid amide-based releasing agent or a silica powder or antistatic treatment by coating, kneading, or vapor deposition. Particularly, releasability from the pressure-sensitive adhesive layer can further be improved by appropriately subjecting the surface of the release film to release treatment, such as silicone treatment, long-chain alkyl treatment, or fluorine treatment.

The transparent resin film substrate is not particularly limited, and various resin films having transparency are used. The resin film is formed from a single-layer film. Examples of a material thereof include polyester-based resins such as polyethylene terephthalate and polyethylene naphthalate, acetate-based resins, polyethersulfone-based resins, polycarbonate-based resins, polyamide-based resins, polyimide-based resins, polyolefin-based resins, (meth)acrylic resins, polyvinyl chloride-based resins, polyvinylidene chloride-based resins, polystyrene-based resins, polyvinyl alcohol-based resins, polyarylate-based resins, and polyphenylenesulfide-based resins. Among them, polyester-based resins, polyimide-based resins, and polyethersulfone-based resins are particularly preferred. The film substrate preferably has a thickness of 15 to 200 μm.

### <Optical Film Having Pressure-Sensitive Adhesive Layer>

An optical film having a pressure-sensitive adhesive layer according to the present invention includes the above-described pressure-sensitive adhesive layer provided on at least one of surfaces of an optical film. It is to be noted that a method for forming the pressure-sensitive adhesive layer is as described above.

As the optical film, one for use in producing an image display device such as a liquid crystal display is used, and the type of the optical film is not particularly limited. An example of the optical film is a polarizing film. As the polarizing film, one having a polarizer and a transparent protective film provided on one or both of the surfaces of the polarizer is generally used. Other examples of the optical film include optical layers for use in producing a liquid crystal display, such as a reflector, a transreflector, a retardation film (including a half wavelength plate or a quarter wavelength plate), a viewing angle compensation film, and a brightness enhancement film. These optical films may be used singly, or one or two or more of these optical films may be laminated on the polarizing film when practically used.

The polarizer is not particularly limited, and various polarizers may be used. Examples of the polarizer include a product obtained by uniaxially stretching a hydrophilic polymer film, such as a polyvinyl alcohol-based film, a partially-formalized polyvinyl alcohol-based film, or partially-saponified ethylene-vinyl acetate copolymer-based film, to which a dichroic material such as iodine or a dichroic dye has been adsorbed, or a polyene-based oriented film such as a dehydration product of polyvinyl alcohol or a dehydrochlorination product of vinyl chloride. Among them, a polarizer including a polyvinyl alcohol-based film and a dichroic material such as iodine is preferred, and an iodine-based polarizer containing iodine and/or an iodine ion is more preferred. The thicknesses of these polarizers are not particularly limited, but are generally about 5 to 80 μm.

The polarizer constituted from a uniaxially-stretched polyvinyl alcohol-based film dyed with iodine can be produced by immersing polyvinyl alcohol in an aqueous iodine solution to dye the polyvinyl alcohol and stretching the polyvinyl alcohol 3 to 7 times its original length. If necessary, the polyvinyl alcohol may be immersed in an aqueous solution of potassium iodide or the like that may contain boric acid, zinc sulfate, zinc chloride, or the like. Further, if necessary, the polyvinyl alcohol-based film may be immersed in water for washing before dyeing. By washing the polyvinyl alcohol-based film with water, soil or a blocking agent on the surface of the polyvinyl alcohol-based film can be washed away, and the polyvinyl alcohol-based film can be swelled, which is effective at preventing uneven dyeing. The stretching may be performed either before or after dyeing with iodine, or may be performed while dyeing is performed. The polyvinyl alcohol-based film may be stretched in an aqueous solution of boric acid or potassium iodide or a water bath.

In the present invention, a thin polarizer having a thickness of 10 μm or less may also be used. From the viewpoint of thickness reduction, the thickness is preferably 1 to 7 μm. Such a thin polarizer is preferred because it has a small thickness variation, excellent visibility, and excellent durability due to a small dimensional change, and the thickness of the polarizing film can be reduced.

Typical examples of the thin polarizer include thin polarizing films disclosed in JP 51-069644 A, JP 2000-338329 A, WO 2010/100917, WO 2010/100917, Japanese Patent No. 4751481, and JP 2012-073563 A. These thin polarizing films can be obtained by a method including the step of stretching a laminate of a polyvinyl alcohol-based resin (hereinafter, also referred to as PVA-based resin) layer and a resin substrate for stretching and the step of dyeing. This production method makes it possible to perform stretching without a problem such as fracture caused by stretching even when the PVA-based resin layer is thin because the PVA-based resin layer is supported by the resin substrate for stretching.

Among the thin polarizing films obtained by such a production method including the step of stretching a laminate and the step of dyeing, from the viewpoint that high ratio stretching can be performed to improve polarization performance, those disclosed in WO 2010/100917, WO 2010/100917, Japanese Patent No. 4751481, and JP 2012-073563 A are preferred which are obtained by production methods including the step of performing stretching in an aqueous boric acid solution, and those disclosed in Japanese Patent No. 4751481 and JP 2012-073563 A are particularly preferred, which are obtained by production methods including the step of performing auxiliary in-air stretching before stretching in an aqueous boric acid solution.

As a material for forming the transparent protective film provided on one or both of the surfaces of the polarizer, for example, a thermoplastic resin is used which is excellent in transparency, mechanical strength, thermal stability, moisture barrier properties, and isotropy. Specific examples of such a thermoplastic resin include cellulose resins such as triacetyl cellulose, polyester resins, polyethersulfone resins, polysulfone resins, polycarbonate resins, polyamide resins, polyimide resins, polyolefin resins, (meth)acrylic resins, cyclic polyolefin resins (norbornene-based resins), polyarylate resins polystyrene resins, polyvinyl alcohol resins, and mixtures of two or more of them. It is to be noted that the transparent protective film is adhered to one of the surfaces of the polarizer with an adhesive layer, but on the other surface of the polarizer, a (meth)acrylic, urethane-based, acrylic urethane-based, epoxy-based, or silicone-based thermosetting or UV-curable resin may be used as a transparent protective film. The transparent protective film may contain any one or more appropriate dopants. Examples of the dopants include a UV absorber, an antioxidant, a lubricant, a plasticizer, a releasing agent, an anti-coloring agent, a flame retardant, a nucleating agent, an antistatic agent, a pigment, and a coloring agent. The amount of the thermoplastic resin contained in the transparent protective film is preferably 50 to 100 wt %, more preferably 50 to 99 wt %, even more preferably 60 to 98 wt %, particularly preferably 70 to 97 wt %. If the amount of the thermoplastic resin contained in the transparent protective film is 50 wt % or less, there is a fear that high transparency that the thermoplastic resin originally has cannot sufficiently be developed.

The thickness of the protective film can appropriately be set, but is usually about 10 to 200 μm from the viewpoint of strength, workability such as handleability, and thinness.

The polarizer and the protective film are usually closely adhered to each other via a water-based adhesive or the like. Examples of the water-based adhesive include isocyanate-based adhesives, polyvinyl alcohol-based adhesives, gelatin-based adhesives, vinyl-based latex-based, water-based polyurethanes, and water-based polyesters. Other than the above, a UV-curable adhesive or an electron beam-curable adhesive may be used as an adhesive for adhering the polarizer and the transparent protective film to each other. The electron beam-curable adhesive for polarizing film has appropriate adhesiveness to the above-mentioned various transparent protective films. The adhesive may contain a metallic compound filler.

In the present invention, a retardation film or the like may be formed on the polarizer instead of the transparent protective film of the polarizing film. Further, another transparent protective film or a retardation film may further be provided on the transparent protective film.

The surface of the transparent protective film to which the polarizer is not adhered may have a hard coat layer formed thereon, or may be subjected to anti-reflection treatment, treatment for preventing sticking, or treatment for the purpose of diffusion or anti-glare.

Further, an anchor layer may be provided between the polarizing film and the pressure-sensitive adhesive layer. A material for forming the anchor layer is not particularly limited, and examples thereof include various polymers, sols of metallic oxides, and silica sol. Among them, polymers are particularly preferably used. The polymers to be used may be of any of a solvent-soluble type, a water-dispersible type, and a water-soluble type.

Examples of the polymers include polyurethane-based resins, polyester-based resins, acrylic resins, polyether-based resins, cellulose-based resins, polyvinyl alcohol-based resins, polyvinyl pyrrolidone, and polystyrene-based resins.

When the pressure-sensitive adhesive layer of the optical film having a pressure-sensitive adhesive layer is exposed, the pressure-sensitive adhesive layer may be protected with a release film (separator) until the optical film having a pressure-sensitive adhesive layer is practically used. Examples of the release film include those mentioned above. When a release film is used as a substrate for forming the pressure-sensitive adhesive layer, and the pressure-sensitive adhesive layer on the release film and an optical film are adhered to each other, the release film can be used as a release film for the pressure-sensitive adhesive layer of the resulting optical film having a pressure-sensitive adhesive layer, which makes it possible to simplify the production process.

### <Transparent Conductive Substrate>

The optical film having a pressure-sensitive adhesive layer according to the present invention may be adhered to a transparent conductive layer of a transparent conductive substrate in which the transparent conductive layer is provided on a transparent substrate, and the resultant may be used as an optical laminate.

A material for forming the transparent conductive layer of the transparent conductive substrate is not particularly limited. For example, an oxide of at least one metal selected from the group consisting of indium, tin, zinc, gallium, antimony, titanium, silicon, zirconium, magnesium, aluminum, gold, silver, copper, palladium, and tungsten is used. If necessary, the metallic oxide may further contain a metallic atom shown in the above group. For example, an indium-tin composite oxide (indium oxide containing tin oxide, ITO), tin oxide containing antimony, or the like is preferably used, and ITO is particularly preferably used. The ITO preferably contains 80 to 99 wt % of indium oxide and 1 to 20 wt % of tin oxide.

Examples of the ITO include crystalline ITO and amorphous ITO, and either of them can suitably be used.

The thickness of the transparent conductive layer is not particularly limited, and is preferably 10 nm or more, more preferably 15 to 40 nm, even more preferably 20 to 30 nm.

A method for forming the transparent conductive layer is not particularly limited, and a conventionally-known method may be used. Specific examples of the method include vacuum deposition, sputtering, and ion plating. Depending on a desired film thickness, an appropriate method may be used.

A material of the transparent substrate is not particularly limited as long as a transparent substrate can be obtained, and examples thereof include glass and a transparent resin film substrate. Examples of the transparent resin film substrate include those mentioned above.

If necessary, an undercoat layer, an oligomer blocking layer, or the like may be provided between the transparent conductive layer and the transparent substrate.

### <Image Display Device>

An image display device according to the present invention includes a liquid crystal cell or an organic EL cell having the above-described optical laminate, wherein the pressure-sensitive adhesive layer of the abovedescribed optical film having a pressure-sensitive adhesive layer is adhered to at least one surface of the liquid crystal cell or the organic EL cell.

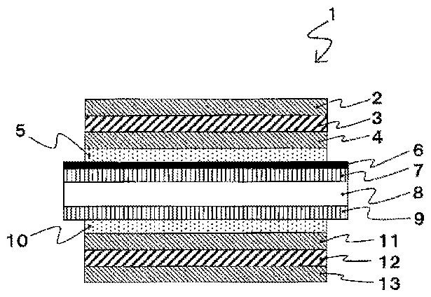

The liquid crystal cell used in the image display device according to the present invention includes a transparent conductive substrate in which a transparent conductive layer is provided on a transparent substrate. The transparent conductive substrate is usually provided on the viewing side of the liquid crystal cell. A liquid crystal cell-containing liquid crystal panel usable in the present invention will be described with reference to FIG. 1. However, the present invention is not limited to what is shown in FIG. 1.

An example of a liquid crystal panel 1 that may be included in the image display device according to the present invention has a structure in which, from the viewing side, a viewing-side transparent protective film 2, a polarizer 3, a liquid crystal cell-side transparent protective film 4, a pressure-sensitive adhesive layer 5, a transparent conductive layer 6, a transparent substrate 7, a liquid crystal layer 8, a transparent substrate 9/a pressure-sensitive adhesive layer 10, a liquid crystal cell-side transparent protective film 11, a polarizer 12, and a light source-side transparent protective film 13 are provided. In FIG. 1, a polarizing film having a pressure-sensitive adhesive layer used as the optical film having a pressure-sensitive adhesive layer according to the present invention corresponds to a structure having the viewing side-transparent protective film 2, the polarizer 3, the liquid crystal cell-side transparent protective film 4, and the pressure-sensitive adhesive layer 5. Further, in FIG. 1, a transparent conductive substrate used in the present invention corresponds to a structure having the transparent conductive layer 6 and the transparent substrate 7. Further, in FIG. 1, a liquid crystal cell having the transparent conductive substrate used in the present invention corresponds to a structure having the transparent conductive layer 6, the transparent substrate 7, the liquid crystal layer 8, and the transparent substrate 9.

In addition to the above constituents, the liquid crystal panel 1 may appropriately include optical films such as a retardation film, a viewing angle compensation film, and a brightness enhancement film.

The liquid crystal layer 8 is not particularly limited, and may be of any type such as a TN type, an STN type, a n type, a VA type, or an IPS type. A material of the transparent substrate 9 (light source side) is not particularly limited as long as a transparent substrate can be obtained. Examples of such a material include glass and a transparent resin film substrate. Examples of the transparent resin film substrate include those mentioned above.

As the light source-side pressure-sensitive adhesive layer 10, the liquid crystal cell-side transparent protective film 11, the polarizer 12, and the light source-side transparent protective film 13, those conventionally used in this field may be used or those mentioned in this description may also be suitably used.

Examples of an image display device to which the liquid crystal panel can be applied include a liquid crystal display device, an electroluminescence (EL) display, a plasma display (PD), and a field emission display (FED). The image display device can be used in home appliances, cars, public information displays (PIDs), and the like, and are particularly suitably used in cars and PIDs because the pressure-sensitive adhesive layer according to the present invention has reworkability and high durability against a transparent conductive layer.

### EXAMPLES

Hereinbelow, the present invention will specifically be described with reference to examples, but is not limited to these examples. It is to be noted that part(s) and % in each of the examples are all by weight. In the following description, conditions for allowing any material to stand at room temperature are 23° C. and 65% RH unless otherwise specified.

### <Measurement of Weight-Average Molecular Weight of (Meth)Acrylic Polymer (A)>

The weight-average molecular weight (Mw) of a (meth)acrylic polymer (A) was measured by GPC (gel permeation chromatography). The Mw/Mn was also measured in the same manner.
Analyzer: HLC-8120GPC manufactured by Tosoh Corporation
Column: G7000H_{XL}+GMH_{XL}+GMH_{XL} manufactured by Tosoh Corporation
Column size: 7.8 mm×30 cm (each column), total: 90 cm
Column temperature: 40° C.
Flow rate: 0.8 mL/min
Injected amount: 100 μL
Eluent: Tetrahydrofuran
Detector: Differential refractometer (RI)
Standard sample: polystyrene

### <Synthesis of Organopolysiloxane Compounds>

### Synthetic Examples 1 and 2

Organopolysiloxane compounds (B1) and (B2) having compositions shown in Table 1 were synthetically obtained

TABLE 1

| | | Ratio of | Ratio of | Ratio of |
|---|---|---|---|---|
| | | silicon | silicon | silicon |
| | | having | having acid | having |
| Silicon | Kind of | alkoxy | anhydride | polyether |
| compound | alkoxy | group | group | group |
| (B) | group | (mol %) | (mol %) | (mol %) |
| (B1) | Methoxy | 73 | 27 | — |
| (B2) | Ethoxy | 70 | 30 | — |

### <Analysis of Composition of Organopolysiloxane Compound>

The composition of each of the organopolysiloxane compounds was determined by ¹H-NMR measurement performed under the following conditions.
Analyzer: AVANCEIII 600 with Cryo Probe manufactured by Bruker Biospin
Observing frequency: 600 MHz (1H)
Measurement solvent: CDCl₃
Measurement temperature: 300 K
Chemical shift reference: measurement solvent [(1H: 7.25 ppm]

### Synthetic Example 3

An organopolysiloxane compound (B3) having a composition shown in Table 2 was synthetically obtained according to Example 2 described in JP-A-2013-129809.

TABLE 2

| | | | Ratio of | |
|---|---|---|---|---|
| | | Ratio of | silicon | Ratio of |
| | | silicon | having | silicon |
| | | having | acid | having |
| Silicon | Kind of | alkoxy | anhydride | polyether |
| compound | alkoxy | group | group | group |
| (B) | group | (mol %) | (mol %) | (mol %) |
| (B3) | Methoxy | 66 | 27 | 7 |

### <Preparation of Polarizing Film>

A polyvinyl alcohol film having a thickness of 80 μm was stretched to 3 times between rolls different in velocity ratio while dyed in a 0.3% iodine solution at 30° C. for 1 minute. Then, the film was stretched to a total stretch ratio of 6 times while immersed in an aqueous solution containing 4% of boric acid and 10% of potassium iodide at 60° C. for 0.5 minutes. Then, the film was washed by immersion in an aqueous solution containing 1.5% of potassium iodide at 30° C. for 10 seconds, and was then dried at 50° C. for 4 minutes to obtain a polarizer having a thickness of 30 μm. A saponified triacetyl cellulose film having a thickness of 80 μm was adhered to both surfaces of the polarizer with a polyvinyl alcohol-based adhesive to prepare a polarizing film.

### Example 1

### <Preparation of Acrylic Polymer (A1)>

In a four-necked flask equipped with a stirring blade, a thermometer, a nitrogen gas inlet tube, and a cooler, a monomer mixture containing 76.9 parts of butyl acrylate, 18 parts of benzyl acrylate, 5 parts of acrylic acid, and 0.1 parts of 4-hydroxybutyl acrylate was placed. Further, 0.1 parts of 2,2′-azobisisobutyronitrile was placed as a polymerization initiator together with 100 parts of ethyl acetate per 100 parts of the monomer mixture (solid matter). Nitrogen gas was introduced into the flask for nitrogen purging while the mixture in the flask was gently stirred. Then, a polymerization reaction was performed for 8 hours while the temperature of the liquid in the flask was kept at about 55° C. to prepare a solution of an acrylic polymer (A1) having a weight-average molecular weight (Mw) of 1,950,000 and a Mw/Mn ratio of 3.9.

### <Preparation of Pressure-Sensitive Adhesive Composition>

To 100 parts of the solid matter of the solution of the acrylic polymer (A1) obtained above, 0.4 parts of an isocyanate crosslinking agent (trimethylol propane/tolylene diisocyanate adduct manufactured by Tosoh Corporation under the trade name of “Coronate L”), 0.1 parts of a peroxide crosslinking agent (manufactured by NOF CORPORATION under the trade name of “NYPER BMT”), and 0.05 parts of the organopolysiloxane compound (B1) synthesized in Synthetic Example 1 were added to prepare a solution of an acrylic pressure-sensitive adhesive composition.

### <Production of Polarizing Film Having Pressure-Sensitive Adhesive Layer>

Then, the solution of the acrylic pressure-sensitive adhesive composition obtained above was applied onto one surface of a polyethylene terephthalate film treated with a silicone-based releasing agent (separator film manufactured by Mitsubishi Polyester Film Corporation under the trade name of “MRF38”) so that a pressure-sensitive adhesive layer had a thickness of 20 μm after drying, and was then dried at 155° C. for 1 minute to form a pressure-sensitive adhesive layer (whose moisture content at 23° C. and 55% RH was 0.45%) on the surface of the separator film.
Then, the pressure-sensitive adhesive layer formed on the separator film was transferred onto the polarizing film prepared above to produce a polarizing film having a pressure-sensitive adhesive layer.

### Examples 2 to 15, Comparative Examples 1 to 4

The kinds of monomers used to prepare an acrylic polymer and the ratio among the monomers used in Example 1 were changed as shown in Table 3 and production conditions were controlled to prepare solutions of acrylic polymers having polymer properties (weight-average molecular weight, Mw/Mn) shown in Table 3.

Solutions of acrylic pressure-sensitive adhesive compositions were prepared using the obtained solutions of the acrylic polymers in the same manner as in Example 1 except that the kind or amount of the silicon compound (B) used, the kind or amount of a reactive functional group-containing silane coupling agent used (or a reactive functional group-containing silane coupling agent was not used), and/or the amounts of the crosslinking agents used were changed as shown in Table 3. Further, polarizing films having a pressure-sensitive adhesive layer were produced using the solutions of the acrylic pressure-sensitive adhesive compositions in the same manner as in Example 1.

The polarizing films having a pressure-sensitive adhesive layer obtained above in Examples and Comparative Examples were evaluated in the following manner. The evaluation results are shown in Table 3.

### <Measurement of Amount of Segregated Si>

The polarizing film having a pressure-sensitive adhesive layer was adhered to the same ITO-coated glass plate as used in measurement of adhesive force that will be described later, and was then subjected to autoclave treatment at 50° C. and 5 atm for 15 minutes for complete adhesion. Then, the polarizing film having a pressure-sensitive adhesive layer was peeled off from the ITO-coated glass plate, and the ITO surface was subjected to wide-scan measurement using X-ray photoelectron spectroscopy (ESCA) to perform qualitative analysis. Further, narrow-scan measurement of each of elemental carbon, nitrogen, oxygen, silicon, indium, and tin was performed to calculate the ratio (atomic %) of elemental Si to these elements. It is to be noted that when the surface of the ITO-coated glass plate to which no polarizing film having a pressure-sensitive adhesive layer was adhered was measured, the ratio of elemental Si was less than 0.2 atomic % that is a lower detection limit.
Device: Quantum 2000 manufactured by ULVAC-PHI
X-ray source: monochromatic AlKα-Xray Setting: 200 μmφ [15 kV, 30W]
Photoelectron take-off angle: 45 degrees with respect to a sample surface
Calibration of binding energy: peak derived from C—C bond in C1s spectrum was set to 285.0 eV
Neutralizing condition: combined use of neutralizing gun and Ar ion gun (neutralization mode)

### <Measurement of Adhesive Force>

The Polarizing Film Having a Pressure-Sensitive adhesive layer was cut to have a size of 150×25 mm wide, adhered to an adherend with a laminator, and subjected to autoclave treatment at 50° C. and 5 atm for 15 minutes for complete adhesion. Then, the adhesive force of the sample was measured. The adhesive force was determined by measuring a force (N/25 mm, 80 m long in measurement) required to peel the sample using a tensile tester (Autograph SHIMADZU AG-110 KN) at a peel angle of 90° and a peel rate of 300 mm/min. In the measurement, sampling was performed once per 0.5 s, and an average of measured values was used as a measured value.

As the adherends, a 0.7 mm-thick alkali-free glass plate (manufactured by Corning under the trade name of “EG-XG”) and an ITO-coated glass plate obtained by forming an ITO film on the alkali-free glass plate by sputtering were used to measure the adhesive force against each of the alkali-free glass plate and the ITO. The ITO used had an Sn content of 3 wt %. The Sn content of the ITO was calculated by the formula: weight of Sn atoms/(weight of Sn atoms+weight of In atoms).

From the viewpoint of reworkability, the adhesive force of the pressure-sensitive adhesive layer according to the present invention is preferably 15 N/25 mm or less, more preferably 10 N/25 mm or less, even more preferably 8 N/25 mm or less.

### <Endurance Test>

An ITO-coated glass plate that was the same as that used for measuring adhesive force was used as an adherend. The polarizing film having a pressure-sensitive adhesive layer cut to have a size of 300×220 mm was adhered to the ITO-coated glass plate with a laminator. Then, the sample was subjected to autoclave treatment at 50° C. and 0.5 MPa for 15 minutes to be completely adhered to the ITO-coated glass plate. The sample subjected to such treatment was treated in an atmosphere of 95° C. or 105° C. for 500 hours (heating test) or treated in an atmosphere of 65° C./95% RH for 500 hours (humidification test), and then the appearance of the interface between the polarizing film and the glass plate was visually observed and evaluated according to the following criteria.

### (Evaluation Criteria)

⊙: No change in appearance such as foaming or peeling was observed.
◯: Peeling at edges or foaming was slightly observed, which however did not cause any problem in practical use.
Δ: Peeling at edges or foaming was observed, which however did not practically cause any problem in applications other than special applications.
x: Significant peeling was observed ad edges, which caused a problem in practical use.

### <Reworkability Test>

An ITO-coated glass plate that was the same as that used for measuring adhesive force was used as an adherend. The polarizing film having a pressure-sensitive adhesive layer was cut to have a size of 420 mm long×320 mm wide, adhered to the ITO-coated glass plate with a laminator, subjected to autoclave treatment at 50° C. and 5 atm for 15 minutes for complete adhesion, and then manually peeled off from the ITO-coated glass plate. The test was repeated three times in the above manner to evaluate the reworkability according to the following criteria.
⊙: All the three films could successfully be peeled off without adhesive residue and breakage.
◯: One or two of the three films were broken but could be peeled off by re-peeling.
Δ: All the three films were broken but could be peeled off by re-peeling.
x: None of the three films could be peeled off without adhesive residue or could be peeled off even by repeated peeling due to breakage.

TABLE 3

| | | | | | | | | | | | Reactive | | | | | | | | | | |
|---|---|---|---|---|---|---|---|---|---|---|---|---|---|---|---|---|---|---|---|---|---|
| | | | | | | | | | | | functional | | | | | | | | | | |
| | | | | | | | | | | | group- | | | | | | | | | | |
| | | | | | | | | | | | containing | | | | | | | | | | |
| | | | | | | | | | | | silane | | | | Amount | Adhesive | | | | | |
| | (Meth) acrylic polymer (A) | | | | | | | | | | coupling | | | | of | force | | Durability | | | Reworkability |
| | | Composition | | | | | Molecular weight | | Silicon compound (B) | | agent | | Crosslinking agent | | segregated | (N/25 mm) | | | | 65° C. | test |
| | No. | BA | BzA | NVP | AA | HBA | Mw | Mw/Mn | Kind | parts | Kind | parts | Isocyanate | Peroxide | Si | ITO | Glass | 95° C. | 105° C. | 95% RH | (%) |
| Example 1 | (A1) | 76.9 | 18 | | 5 | 0.1 | 1,950,000 | 3.9 | (B1) | 0.05 | — | — | 0.4 | 0.1 | 0.8 | 14.8 | 10.9 | ○ | Δ | ○ | Δ |
| Example 2 | (A1) | 76.9 | 18 | | 5 | 0.1 | 1,950,000 | 3.9 | (B1) | 0.1 | — | — | 0.4 | 0.1 | 1.2 | 11.3 | 10.4 | ⊙ | Δ | ○ | Δ |
| Example 3 | (A1) | 76.9 | 18 | | 5 | 0.1 | 1,950,000 | 3.9 | (B1) | 0.2 | — | — | 0.4 | 0.1 | 1.4 | 8.3 | 8.0 | ⊙ | ○ | ○ | ○ |
| Example 4 | (A1) | 76.9 | 18 | | 5 | 0.1 | 1,950,000 | 3.9 | (B1) | 0.4 | — | — | 0.4 | 0.1 | 1.9 | 6.6 | 6.0 | ⊙ | ⊙ | ○ | ⊙ |
| Example 5 | (A1) | 76.9 | 18 | | 5 | 0.1 | 1,950,000 | 3.9 | (B1) | 0.6 | — | — | 0.4 | 0.1 | 2.2 | 6.3 | 5.7 | ⊙ | ⊙ | ○ | ⊙ |
| Example 6 | (A1) | 76.9 | 18 | | 5 | 0.1 | 1,950,000 | 3.9 | (B1) | 1 | — | — | 0.4 | 0.1 | 2.6 | 56 | 4.9 | ⊙ | ⊙ | ○ | ⊙ |
| Example 7 | (A1) | 76.9 | 18 | | 5 | 0.1 | 1,950,000 | 3.9 | (B1) | 2 | — | — | 0.4 | 0.1 | 3 | 5.2 | 4.7 | ○ | ○ | ○ | ⊙ |
| Example 8 | (A1) | 76.9 | 18 | | 5 | 0.1 | 1,950,000 | 3.9 | (B1) | 3 | — | — | 0.4 | 0.1 | 3.2 | 4.8 | 4.5 | ○ | ○ | Δ | ⊙ |
| Example 9 | (A1) | 76.9 | 18 | | 5 | 0.1 | 1,950,000 | 3.9 | (B2) | 1 | — | — | 0.4 | 0.1 | 2.4 | 8.6 | 7.8 | ○ | ○ | ○ | ○ |
| Example 10 | (A2) | 76.9 | 18 | 2 | 3 | 0.1 | 1,800,000 | 3.5 | (B1) | 0.4 | — | — | 0.6 | 0.2 | 1.8 | 6.0 | 6.9 | ⊙ | ⊙ | ○ | ⊙ |
| Example 11 | (A3) | 77.5 | 18 | 4.4 | | 0.1 | 1,680,000 | 3.8 | (B1) | 0.2 | — | — | 0.3 | 0.3 | 2.1 | 5.9 | 7.0 | ○ | Δ | ○ | ⊙ |
| Example 12 | (A1) | 76.9 | 18 | | 5 | 0.1 | 1,950,000 | 3.9 | (B1) | 0.6 | X-41- | 0.2 | 0.4 | 0.1 | 2 | 6.0 | 5.0 | ⊙ | ⊙ | ⊙ | ⊙ |
| | | | | | | | | | | | 1056 | | | | | | | | | | |
| Example 13 | (A1) | 76.9 | 18 | | 5 | 0.1 | 1,950,000 | 3.9 | (B1) | 0.4 | X-41- | 0.2 | 0.4 | 0.1 | 1.8 | 6.3 | 6.0 | ⊙ | ⊙ | ⊙ | ⊙ |
| | | | | | | | | | | | 1810 | | | | | | | | | | |
| Example 14 | (A1) | 76.9 | 18 | | 5 | 0.1 | 1,950,000 | 3.9 | (B3) | 0.4 | — | — | 0.4 | 0.1 | 0.8 | 6.0 | 5.5 | Δ | Δ | ○ | ⊙ |
| Example 15 | (A3) | 77.5 | 18 | 4.4 | | 0.1 | 1,680,000 | 3.8 | (B4) | 0.1 | — | — | 0.3 | 0.3 | 1.2 | 6.9 | 4.2 | Δ | Δ | ○ | ⊙ |
| Compar- | (A1) | 76.9 | 18 | | 5 | 0.1 | 1,950,000 | 3.9 | — | — | — | — | 0.4 | 0.1 | <0.2 | 16.1 | 11.9 | ○ | x | x | x |
| ative | | | | | | | | | | | | | | | | | | | | | |
| Example 1 | | | | | | | | | | | | | | | | | | | | | |
| Compar- | (A1) | 76.9 | 18 | | 5 | 0.1 | 1,950,000 | 3.9 | X-41- | 0.2 | — | — | 0.4 | 0.1 | <0.2 | 15.6 | 6.0 | ○ | x | ○ | x |
| ative | | | | | | | | | 1056 | | | | | | | | | | | | |
| Example 2 | | | | | | | | | | | | | | | | | | | | | |
| Compar- | (A1) | 76.9 | 18 | | 5 | 0.1 | 1,950,000 | 3.9 | PDMS | 0.4 | — | — | 0.4 | 0.1 | <0.2 | 16.0 | 11.9 | x | x | Δ | x |
| ative | | | | | | | | | | | | | | | | | | | | | |
| Example 3 | | | | | | | | | | | | | | | | | | | | | |
| Compar- | (A4) | 99 | | | | 1 | 1,800,000 | 4.1 | — | — | — | — | 0.4 | 0.1 | <0.2 | 4.5 | 5.0 | x | x | x | ⊙ |
| ative | | | | | | | | | | | | | | | | | | | | | |
| Example 4 | | | | | | | | | | | | | | | | | | | | | |

In Table 3, the monomers used to prepare the (meth)acrylic polymers (A) are represented by the following abbreviations:
BA: butyl acrylate;
BzA: benzyl acrylate;
NVP: N-vinyl-pyrrolidone;
AA: acrylic acid; and
HBA: 4-hydroxybutyl acrylate.

In Table 3, (B4) represents a polyether-modified (oxyalkylene chain-containing) organopolysiloxane compound (manufactured by Shin-Etsu Chemical Co., Ltd. under the trade name of “KF-353”);

X-41-1056 represents an epoxy group-containing oligomer-type silane coupling agent (manufactured by Shin-Etsu Chemical Co., Ltd.);

X-41-1810 represents a mercapto group-containing oligomer-type silane coupling agent (manufactured by Shin-Etsu Chemical Co., Ltd.);

PDMS represents polydimethylsiloxane (manufactured by Shin-Etsu Chemical Co., Ltd. under the trade name of “KF-96-20CS”)

Isocyanate represents an isocyanate crosslinking agent (manufacture by Tosoh Corporation under the trade name of “Coronate L”, trimethylolpropane/tolylenediisocyanate adduct); and

Peroxide represents a peroxide crosslinking agent (manufactured by NOF Corporation under the trade name of “NYPER BMT”).

### DESCRIPTION OF REFERENCE SIGNS

1 Liquid crystal panel
2 Viewing-side transparent protective film
3 Polarizer
4 Liquid crystal cell-side transparent protective film
5 Pressure-sensitive adhesive layer
6 Transparent conductive layer
7 Transparent substrate
8 Liquid crystal layer
9 Transparent substrate
10 Pressure-sensitive adhesive layer
11 Liquid crystal cell-side transparent protective film
12 Polarizer
13 Light source-side transparent protective film

1. A pressure-sensitive adhesive layer comprising a pressure-sensitive adhesive composition containing a (meth)acrylic polymer (A) containing at least an alkyl (meth)acrylate as a monomer unit and a silicon compound (B), wherein
the silicon compound (B) is an organopolysiloxane compound, and
when a laminate, which is obtained by adhering the pressure-sensitive adhesive layer of a polarizing film having a pressure-sensitive adhesive layer which has a polarizing film and the pressure-sensitive adhesive layer to an indium-tin composite oxide layer of a transparent conductive substrate having a transparent substrate and an indium-tin composite oxide layer, is subjected to autoclave treatment under conditions of 50° C. and 5 atmospheres for 15 minutes, and then the pressure-sensitive adhesive layer is peeled off, the ratio of elemental silicon to a total amount of elemental carbon, nitrogen, oxygen, silicon, indium, and tin detected in a surface of the indium-tin composite oxide layer by X-ray photoelectron spectroscopy is 0.5 atomic % or more but 5 atomic % or less.

2. The pressure-sensitive adhesive layer according to claim 1, wherein an amount of the silicon compound (B) is 0.05 to 10 parts by weight per 100 parts by weight of the (meth)acrylic polymer (A).

3. The pressure-sensitive adhesive layer according to claim 1, wherein the pressure-sensitive adhesive composition contains a reactive functional group-containing silane coupling agent, and
the reactive functional group is at least one of an epoxy group, a mercapto group, an amino group, an isocyanate group, an isocyanurate group, a vinyl group, a styryl group, an acetoacetyl group, a ureido group, a thiourea group, a (meth)acrylic group, and a heterocyclic group.

4. The pressure-sensitive adhesive layer according to claim 3, wherein an amount of the reactive functional group-containing silane coupling agent is 0.01 to 10 parts by weight per 100 parts by weight of the (meth)acrylic polymer (A).

5. The pressure-sensitive adhesive layer according to claim 1, wherein the pressure-sensitive adhesive composition further contains, as a monomer unit, at least one copolymerizable monomer selected from the group consisting of an aromatic ring-containing (meth)acrylate, an amide group-containing monomer, a carboxyl group-containing monomer, and a hydroxyl group-containing monomer.

6. The pressure-sensitive adhesive layer according to claim 5, wherein an amount of the carboxyl group-containing monomer is 0.1 to 15% by weight with respect to a total amount of monomer components forming the (meth)acrylic polymer (A).

7. The pressure-sensitive adhesive layer according to claim 1, wherein the pressure-sensitive adhesive composition contains a crosslinking agent.

8. The pressure-sensitive adhesive layer according to claim 1, whose adhesive force to an indium-tin composite oxide layer is 15 N/25 mm or less under conditions of a peel angle of 90° and a peel rate of 300 mm/min.

9. An optical film having a pressure-sensitive adhesive layer, comprising an optical film and the pressure-sensitive adhesive layer according to claim 1.

10. An optical laminate comprising a transparent conductive substrate having a transparent substrate and a transparent conductive layer and the optical film having a pressure-sensitive adhesive layer according to claim 9, wherein the pressure-sensitive adhesive layer of the optical film having a pressure-sensitive adhesive layer is adhered to the transparent conductive layer of the transparent conductive substrate.

11. An image display device using the optical film having a pressure-sensitive adhesive layer according to claim 9.

12. An image display device using the optical laminate according to claim 10.
